(19) United States
(12) Patent Application Publication
(10) Pub. No.: US 2008/0019398 A1
(43) Pub. Date: Jan. 24, 2008

(54) Clock recovery in wireless media streaming

(75) Inventors: Michael Genossar, Modi'in (IL); Florin Calin, Hod-Hasharon (IL); Eran Igler, Tel Aviv (IL); Avner Taieb, Petach Tikva (IL)

Correspondence Address: MICHAEL GENOSSAR, 62 BINYAMIN, MODI'IN, 71700, omitted

(73) Assignee: Adimos Systems Ltd., Kfar Saba (IL)

(21) Appl. No.: 11/489,830

(22) Filed: Jul. 20, 2006

(51) Int. Cl. H04J 3/00

(52) U.S. Cl. 370/498

(57) ABSTRACT

There is provided, in accordance with some embodiments of the present invention, a system, method and circuit for clock recovery and synchronization in wireless media streaming. More specifically the adverse affect of jitter on the recovery of a wirelessly transmitted MPEG2 Transport Stream (TS) signal at a receiver is addressed through the implementation of algorithms based on observed empirical results, as well as introducing additional timing signals at the transmitter.

### FIELD OF INVENTION

The present invention generally relates to the field of communication. More specifically, the present invention relates to a system circuit, algorithm, and method for the radio frequency transmission of media or content related data signals from a media source to a presentation device, while maintaining a required level of system synchronization between the transmitting and receiving stages for the proper decoding and presentation of these signals.

### BACKGROUND

Since the development of crude communication systems based on electrical signals, the world's appetite for more and more advanced forms of communication has continually increased. From wired cable networks over which operators would exchange messages using Morse-Code, to the broadband wireless networks of today, whenever technology has provided a means by which to communicate more information, people have found a use for that means, and have demanded more.

In the ever-evolving field of communications, new forms of media (e.g. sound, images, video, interactive multi-media content, etc.) are constantly being developed and improved. Most homes, businesses and various other locations in the developed world today have devices capable of receiving, displaying, or playing content in various formats and media types. More specifically, today's modern home, office, or home-office may contain at least one display device/screen such as a television or monitor, which can be a traditional cathode ray tube (CRT), a liquid crystal display (LCD), or plasma display, and most likely will also include various media content sources such as a computer, a stereo, a DVD player, personal video recorder (PVR), and a proprietary content provider's decoder set top box (STB) to deliver cable, wireless, or direct broadcast satellite (DBS) signals. The terms “Home Theater”, “Home Entertainment Center” or “Media Center” have been coined to designate a set of devices or even complex media presentation systems for the presentation of content to persons within a home or office. With the continued evolution of the various media types in which content is being delivered, the devices and systems used to receive and present that content is also evolving and growing in number.

As the number and complexity of devices and systems used grows, so does the need to interconnect these devices. Since many devices need to be connected with other devices in order to function fully and properly (for example a DVD player needs to be connected to a Video Display and to an Audio Output System), the need for a means to establish efficient connections or networks of connections between various home devices and systems is growing. Since modern communication devices and networks today are best characterized by features such as high bandwidth/data-rate, complex communication protocols, various transmission medium, and various access means, solutions for interconnecting media related devices and systems to date have typically centered around wiring the devices to one another using various cables of various configurations and sizes. For example, fiber optic cables, which are used as part of data networks spanning much of the world's surface, are sometimes used to connect the audio output of a CD or DVD device to an Audio System, while coaxial cables or shielded wires are used to deliver video signals.

In addition to the ever increasing societal demand for greater varieties of media content, we are now requiring an increased level of wireless connectivity. Radio frequency (RF) wireless transceivers, protocols and networks (Bluetooth, WiFi, Wi-Max, etc.) have been used to interconnect various devices in the home and office. Although wireless interconnection of devices is typically easier and cleaner to implement than using wiring that needs to be installed and placed so as not to be intrusive and/or unaesthetic, the use of wireless transceivers for interconnection of devices introduces variable delays associated with the compression (due to bandwidth limitations of wireless networks), transmission, and decompression of media related data. More specifically, since by definition, the given multimedia content or presentation may have several media components, such as video and audio, and since each media component may require a different level and method of compression, each of the related media components may require a different level of processing in order to be transmitted to and presented at the respective output devices. Due to the separation of the transmitter and receiver(s) in a wireless system a method of synchronization between them must be established.

The most widely employed wireless connectivity standard is the Institute of Electrical and Electronics Engineers (IEEE) 802.11. The 802.11 refers to a family of specifications developed by the IEEE for wireless local area network (WLAN) technology. A WLAN is a type of local area network that uses high-frequency radio waves rather than wires to communicate between nodes. 802.11 specifies an over-the-air interface between a wireless client and a base station or between two wireless clients. The IEEE accepted the 802.11 specification in 1997.

There are several specifications in the 802.11 family including:
802.11—applies to wireless LANs and provides 1 or 2 Mbps transmission in the 2.4 GHz band using either frequency hopping spread spectrum (FHSS) or direct sequence spread spectrum (DSSS).
802.11a—an extension to 802.11 that applies to wireless LANs and provides up to 54 Mbps in the 5 GHz band. 802.11a uses an orthogonal frequency division multiplexing encoding scheme rather than FHSS or DSSS.
802.11b (also referred to as 802.11 High Rate or Wi-Fi)—an extension to 802.11 that applies to wireless LANS and provides 11 Mbps transmission (with a fallback to 5.5, 2 and 1 Mbps) in the 2.4 GHz band. 802.11b uses only DSSS. 802.11b was a 1999 ratification to the original 802.11 standard, allowing wireless functionality comparable to Ethernet.
802.11e as of late 2005 has been approved as a standard that defines a set of Quality of Service enhancements for LAN applications, in particular the 802.11 WiFi standard. The standard is considered of critical importance for delay-sensitive applications, such as Voice over Wireless IP and Streaming Multimedia.
802.11g—applies to wireless LANs and provides up to 54 Mbps in the 2.4 GHz band.

In January 2004 the IEEE announced that it will develop a new standard for wide-area wireless networks. The real speed would be 100 Mbit/s (even 250 Mbit/s in PHY level), or up to 4-5 times faster than 802.11g, and perhaps 50 times faster than 802.11b. As projected, 802.11n will also offer a better operating distance than current networks. The standardization progress is expected to be completed in 2007. 802.11n builds upon previous 802.11 standards by adding MIMO (multiple-input multiple-output). The additional transmitter and receiver antennas allow for increased data throughput through spatial multiplexing and increased range by exploiting the spatial diversity through coding schemes like space-time block coding.

An additional wireless standard currently under development is Ultra-Wideband (UWB). UWB is a wireless radio technology designed to transmit data within short ranges (up to 10 meters). UWB transmits at very high bandwidths (the minimum bandwidth (BW) requirement is 500 MHz), and supports high bit rates (up to 480 Mbps) while using very low transmit power levels. UWB is suitable for exchanging data between consumer electronics (CE), PCs, PC peripherals, and mobile devices at very high speeds over short distances. For instance, it could transfer all the pictures on a digital camera's memory card to a computer in a few seconds.

The bandwidth limitations of wired and to a greater extent wireless networks mandate a high degree of signal compression. Various methods for compression of video and audio have been devised. Among the most common compression standards are JPEG and various MPEG standards

JPEG

1. Introduction

JPEG (Joint Photographic Experts Group) is a standard for still image compression. The JPEG committee has developed standards for the lossy, lossless, and nearly lossless compression of still images, and the compression of continuous-tone, still-frame, monochrome, and color images. The JPEG standard provides three main compression techniques from which applications can select elements satisfying their requirements. The three main compression techniques are (i) Baseline system, (ii) Extended system and (iii) Lossless mode technique. The Baseline system is a simple and efficient Discrete Cosine Transform (DCT)-based algorithm with Huffman coding restricted to 8 bits/pixel inputs in sequential mode. The Extended system enhances the baseline system to satisfy broader application with 12 bits/pixel inputs in hierarchical and progressive mode and the Lossless mode is based on predictive coding, DPCM (Differential Pulse Coded Modulation), independent of DCT with either Huffman or arithmetic coding.

2. JPEG Compression

An example of a JPEG encoder block diagram may be found in Compressed Image File Formats: JPEG, PNG, GIF, XBM, BMP (ACM Press) by John Miano, A more complete technical description may be found in ISO/EEC International Standard 10918-1 (see World Wide Web atjpeg.org/jpeg/) An original picture, such as a video frame image is partitioned into 8×8 pixel blocks, each of which is independently transformed using DCT. DCT is a transform function from spatial domain to frequency domain The DCT transform is used in various lossy compression techniques such as MPEG-1, MPEG-2, MPEG-4 and JPEG. The DCT transform is used to analyze the frequency component in an image and discard frequencies which human eyes do not usually perceive. A more complete explanation of DCT maybe found at “Discrete-Time Signal Processing” (Prentice Hall, 2^{nd} edition, February 1999) by Alan V. Oppenheim, Ronald W. Schafer, John R. Buck. All the transform coefficients are uniformly quantized with a user-defined quantization table (also called a q-table or normalization matrix). The quality and compression ratio of an encoded image can be varied by changing elements in the quantization table. Commonly, the DC coefficient in the top-left of a 2-D DCT array is proportional to the average brightness of the spatial block and is variable-length coded from the difference between the quantized DC coefficient of the current block and that of the previous block. The AC coefficients are rearranged to a 1-D vector through zigzag scan and encoded with run-length encoding. Finally, the compressed image is entropy coded, such as by using Huffman coding. The Huffman coding is a variable-length coding based on the frequency of a character. The most frequent characters are coded with fewer bits and rare characters are coded with many bits. A more detailed explanation of Huffman coding may be found at “Introduction to Data Compression” (Morgan Kaufmann, Second Edition, February, 2000) by Khalid Sayood

A JPEG decoder operates in reverse order. Thus, after the compressed data is entropy decoded and the 2-dimensional quantized DCT coefficients are obtained, each coefficient is de-quantized using the quantization table. JPEG compression is commonly found in current digital still camera systems and many Karaoke “sing-along” systems.

Wavelet

Wavelets are transform functions that divide data into various frequency components. They are useful in many different fields, including multi-resolution analysis in computer vision, sub-band coding techniques in audio and video compression and wavelet series in applied mathematics. They are applied to both continuous and discrete signals Wavelet compression is an alternative or adjunct to DCT type transformation compression and is considered or adopted for various MPEG standards, such as MPEG-4. A more complete description may be found at “Wavelet transforms: Introduction to Theory and Application” by Raghuveer M. Rao.

MPEG

The MPEG (Moving Pictures Experts Group) committee started with the goal of standardizing video and audio for compact discs (CDs). A meeting between the International Standards Organization (ISO) and the International Electrotechnical Commission (IEC) finalized a 1994 standard titled MPEG-2, which is now adopted as a video coding standard for digital television broadcasting. MPEG may be more completely described and discussed on the World Wide Web at mpeg.org along with example standards. MPEG-2 is further described at “Digital Video: An Introduction to MPEG-2 (Digital Multimedia Standards Series)” by Barry G. Haskell, Atul Pun, Arun N. Netravali. MPEG-4 is described further in “The MPEG-4 Book” by Touradj Ebrahimi, Fernando Pereira.

MPEG Compression

The objective of the MPEG compression standards is to reduce transmission system bandwidth requirements, increase bandwidth utilization, and decrease signal storage requirements. MPEG compression eliminates redundant signal content, and also eliminates high frequency information that is imperceptible to the viewer. The MPEG standards take analog or digital video signals (and possibly related data such as audio signals or text) and convert them to packets of digital data that are more bandwidth efficient. By generating packets of digital data it is possible to generate signals that do not degrade, provide high quality pictures, and achieve high signal to noise ratios.

MPEG standards are effectively derived from the Joint Pictures Expert Group (JPEG) standard for still images. The MPEG-2 video compression standard achieves high data compression ratios by producing information for a full frame video image only occasionally These full-frame images or “intra-coded” frames (pictures) are referred to as “I-frames”. Each I-frame contains a complete description of a single video frame (image or picture) independent of any other frame, and takes advantage of the nature of the human eye and removes redundant information in the high frequency region that humans traditionally cannot see These “I-frame” images act as “anchor frames” (sometimes referred to as “key frames” or “reference frames”) that serve as reference images within an MPEG-2 stream. Between the I-frames, delta-coding, motion compensation, and a variety of interpolative/predictive techniques are used to encode intervening frames. “Inter-coded” B-frames (bidirectionally-coded frames) and P-frames (predictive-coded frames) are examples of such “in-between” frames encoded between the I-frames, storing only information about differences between the intervening frames they represent with respect to the I-frames (reference frames). The MPEG system consists of two major layers namely, the System Layer (timing information to synchronize video and audio) and Compression Layer.

The MPEG standard stream is organized as a hierarchy of layers consisting of Video Sequence layer, Group-Of-Pictures (GOP) layer, Picture layer, Slice layer, Macroblock layer and Block layer.

The Video Sequence layer begins with a sequence header (and optionally other sequence headers), and usually includes one or more groups of pictures and ends with an end-of-sequence-code. The sequence header contains the basic parameters such as the size of the coded pictures, the size of the displayed video pictures if different, bit rate, frame rate, aspect ratio of the video, the profile and level identification, interlace or progressive sequence identification, private user data, plus other global parameters related to the video.

The GOP layer consists of a header and a series of one or more pictures intended to allow random access, fast search and editing. The GOP header contains a time code used by certain recording devices. It also contains editing flags to indicate whether Bidirectional (B)-pictures following the first Intra (I)-picture of the GOP can be decoded following a random access called a closed GOP. In MPEG, a video sequence is generally divided into a series of GOPs.

The Picture layer is the primary coding unit of a video sequence A picture consists of three rectangular matrices representing luminance (Y) and two chrominance (Cb and Cr or U and V) values The picture header contains information on the picture coding type of a picture (intra (I), predicted (P), Bidirectional (B) picture), the structure of a picture (frame, field picture), the type of the zigzag scan and other information related for the decoding of a picture. For progressive mode video, a picture is identical to a frame and can be used interchangeably, while for interlaced mode video, a picture refers to the top field or the bottom field of the frame.

A slice is composed of a string of consecutive macroblocks which are commonly built from a 2 by 2 matrix of blocks and it allows error resilience in case of data corruption. Due to the existence of a slice in an error resilient environment, a partial picture can be constructed instead of the whole picture being corrupted. If the bitstream contains an error, the decoder can skip to the start of the next slice. Having more slices in the bitstream allows better error hiding, but it wastes bits that could otherwise be used to improve picture quality. The slice is composed of macroblocks traditionally running from left to right and top to bottom where all macroblocks in the I-pictures are transmitted. In P and B-pictures, typically some macroblocks of a slice are transmitted and some are not, that is, they are skipped. However, the first and last macroblock of a slice should always be transmitted. Also the slices should not overlap.

A block consists of the data for the quantized DCT coefficients of an 8×8 block in the macroblock. The 8 by 8 blocks of pixels in the spatial domain are transformed to the frequency domain with the aid of DCT and the frequency coefficients are quantized. Quantization is the process of approximating each frequency coefficient as one of a limited number of allowed values. The encoder chooses a quantization matrix that determines how each frequency coefficient in the 8 by 8 block is quantized. Human perception of quantization error is lower for high spatial frequencies (such as color), so high frequencies are typically quantized more coarsely (with fewer allowed values).

The combination of the DCT and quantization results in many of the frequency coefficients being zero, especially those at high spatial frequencies. To take maximum advantage of this, the coefficients are organized in a zigzag order to produce long runs of zeros. The coefficients are then converted to a series of run-amplitude pairs, each pair indicating a number of zero coefficients and the amplitude of a non-zero coefficient. These run-amplitudes are then coded with a variable-length code, which uses shorter codes for commonly occurring pairs and longer codes for less common pairs. This procedure is more completely described in “Digital Video: An Introduction to MPEG-2” (Chapman & Hall, December, 1996) by Barry G. Haskell, Atul Puri, Arun N. Netravali. A more detailed description may also be found at “Generic Coding of Moving Pictures and Associated Audio Information—Part 2: Videos”, ISO/EEC 13818-2 (MPEG-2), 1994 (see World Wide Web at mpeg.org).

Inter-Picture Coding

Inter-picture coding is a coding technique used to construct a picture by using previously encoded pixels from the previous frames. This technique is based on the observation that adjacent pictures in a video are usually very similar. If a picture contains moving objects and if an estimate of their translation in one frame is available, then the temporal prediction can be adapted using pixels in the previous frame that are appropriately spatially displaced. The picture type in MPEG is classified into three types of picture according to the type of inter prediction used. A more detailed description of inter-picture coding may be found at “Digital Video: An Introduction to MPEG-2” (Chapman & Hall, December, 1996) by Barry G. Haskell, Atul Puri, Arun N. Netravali.

Picture Types

The MPEG standards (MPEG-1, MPEG-2, MPEG-4) specifically define three types of pictures (frames) Intra (I), Predicted (P), and Bidirectional (B).

Intra (I) pictures are pictures that are traditionally coded separately only in the spatial domain by themselves. Since intra pictures do not reference any other pictures for encoding and the picture can be decoded regardless of the reception of other pictures, they are used as an access point into the compressed video. The intra pictures are usually compressed in the spatial domain and are thus large in size compared to other types of pictures.

Predicted (P) pictures are pictures that are coded with respect to the immediately previous I or P-frame. This technique is called forward prediction. In a P-picture, each macroblock can have one motion vector indicating the pixels used for reference in the previous I or P-frames. Since a P-picture can be used as a reference picture for B-frames and future P-frames, it can propagate coding errors. Therefore the number of P-pictures in a GOP is often restricted to allow for a clearer video.

Bidirectional (B) pictures are pictures that are coded by using immediately previous I- and/or P-pictures as well as immediately next I- and/or P-pictures. This technique is called bidirectional prediction. In a B-picture, each macroblock can have one motion vector indicating the pixels used for reference in the previous I- or P-frames and another motion vector indicating the pixels used for reference in the next I- or P-frames. Each macroblock in a B-picture can have up to two motion vectors, where the macroblock is obtained by averaging the two macroblocks referenced by the motion vectors, The averaging of the macroblocks referenced by the motion vectors results in the reduction of noise. In terms of compression efficiency, the B-pictures are the most efficient, P-pictures are somewhat less efficient, and the I-pictures are the least efficient. The B-pictures do not propagate errors because they are not traditionally used as a reference picture for inter-prediction.

Video Stream Composition

The number of I-frames in a MPEG stream (MPEG-1, MPEG-2 and MPEG-4) may be varied depending on the applications needed for random access and the location of scene cuts in the video sequence. In applications where random access is important, I-frames are used often, such as two times a second. The number of B-frames in between any pair of reference (I or P) frames may also be varied depending on factors such as the amount of memory in the encoder and the characteristics of the material being encoded. A typical display order of pictures may be found in “Digital Video: An Introduction to MPEG-2 (Digital Multimedia Standards Series)” by Barry G. Haskell, Atul Puri, Arun N. Netravali and “Generic Coding of Moving Pictures and Associated Audio Information—Part 2. Videos,” ISO/IEC 13818-2 (MPEG-2), 1994 (see World Wide Web at iso.org). The sequence of pictures is re-ordered in the encoder such that the reference pictures needed to reconstruct B-frames are sent before the associated B-frames. A typical encoded order of pictures may be found in “Digital Video: An Introduction to MPEG-2 (Digital Multimedia Standards Series)” by Barry G. Haskell, Atul Puri, Arun N. Netravali and “Generic Coding of Moving Pictures and Associated Audio Information—Part 2: Videos,” ISO/IEC 13818-2 (MPEG-2), 1994 (see World Wide Web at iso.org).

Motion Compensation

In order to achieve a higher compression ratio, the temporal redundancy of the video signal is eliminated by a technique called motion compensation. Motion compensation is utilized in P- and B-pictures at the macro-block level where each macroblock has a spatial vector between the reference macroblock and the macroblock being coded and the error between the reference and the coded macroblock. The motion compensation for macroblocks in P-picture may only use the macroblocks in the previous reference picture (I-picture or P-picture), while macroblocks in a B-picture may use a combination of both the previous and future pictures as a reference pictures (I-picture or P-picture). A more extensive description of aspects of motion compensation may be found in “Digital Video: An Introduction to MPEG-2 (Digital Multimedia Standards Series)” by Barry G. Haskell, Atul Puri, Arun N. Netravali and “Generic Coding of Moving Pictures and Associated Audio Information—Part 2: Videos,” ISO/IEC 13818-2 (MPEG-2), 1994 (see World Wide Web at iso.org).

MPEG-2 System Layer

A main function of MPEG-2 systems is to provide a means of combining several types of multimedia information into one stream. Data packets from several elementary streams (ESs) (such as audio, video, textual data, and possibly other data) are interleaved into a single stream. The ESs consist of compressed data from a single source plus ancillary data needed for synchronization, identification, and characterization of the source information. The ESs themselves are first packetized into either constant-length or variable-length packets to form a Packetized Elementary stream (PES).

MPEG-2 system coding is specified in two forms: the Program Stream (PS) and the Transport Stream (TS). The PS is used in relatively error-free environments such as DVD media, and the TS is used in environments where errors are likely, such as in digital broadcasting. The PS usually carries one program where a program is a combination of various ESs. The PS is made of packs of multiplexed data. Each pack consists of a pack header followed by a variable number of multiplexed PES packets from the various ESs plus other descriptive data. The TS consists of TS packets, such as of 188 bytes, into which relatively long, variable length PES packets are further packetized. Each TS packet consists of a TS Header followed optionally by ancillary data (called an adaptation field), followed typically by one or more PES packets. The TS header usually consists of a sync (synchronization) byte, flags and indicators, packet identifier (PID), plus other information for error detection, timing and other functions. It is noted that the header and adaptation field of a TS packet shall not be scrambled.

In order to maintain proper synchronization between the ESs, for example, containing audio and video streams, synchronization is commonly achieved through the use of time stamp and clock reference. Time stamps for presentation and decoding are generally in units of 90 kHz, indicating the appropriate time according to the clock reference with a resolution of 27 MHz that a particular presentation unit (such as a video picture) should be decoded by the decoder and presented to the output device. A time stamp containing the presentation time of audio and video is commonly called the Presentation Time Stamp (PTS) that maybe present in a PES packet header, and indicates when the decoded picture is to be passed to the output device for display whereas a time stamp indicating the decoding time is called the Decoding Time Stamp (DTS). Program Clock Reference (PCR) in the Transport Stream (TS) and System Clock Reference (SCR) in the Program Stream (PS) indicate the sampled values of the system time clock. In general, the definitions of PCR and SCR may be considered to be equivalent, although there are distinctions. The PCR that may be present in the adaptation field of a TS packet provides the clock reference for one program, where a program consists of a set of ESs that has a common time base and is intended for synchronized decoding and presentation. There may be multiple programs in one TS, and each may have an independent time base and a separate set of PCRs. As an illustration of an exemplary operation of the decoder, the system time clock of the decoder is set to the value of the transmitted PCR (or SCR), and a frame is displayed when the system time clock of the decoder matches the value of the PTS of the frame. For consistency and clarity, the remainder of this disclosure will use the term PCR. However, equivalent statements and applications apply to the SCR or other equivalents or alternatives except where specifically noted otherwise. A more extensive explanation of MPEG-2 System Layer can be found in “Generic Coding of Moving Pictures and Associated Audio Information—Part 2: Systems,” ISO/IEC 13818-1 (MPEG-2), 1994.

Differences Between MPEG-1 and MPEG-2

The MPEG-2 Video Standard supports both progressive scanned video and interlaced scanned video, while the MPEG-1 Video standard only supports progressive scanned video. In progressive scanning, video is displayed as a stream of sequential raster-scanned frames. Each frame contains a complete screen-full of image data, with scan lines displayed in sequential order from top to bottom on the display. The “frame rate” specifies the number of frames per second in the video stream. In interlaced scanning, video is displayed as a stream of alternating, interlaced (or interleaved) top and bottom raster fields at twice the frame rate, with two fields making up each frame. The top fields (also called “upper fields” or “odd fields”) contain video image data for odd numbered scan lines (starting at the top of the display with scan line number 1), while the bottom fields contain video image data for even numbered scan lines. The top and bottom fields are transmitted and displayed in alternating fashion, with each displayed frame comprising a top field and a bottom field. Interlaced video is different from non-interlaced video, which paints each line on the screen in order. The interlaced video method was developed to save bandwidth when transmitting signals but it can result in a less detailed image than comparable non-interlaced (progressive) video

The MPEG-2 Video Standard also supports both frame-based and field-based methodologies for DCT block coding and motion prediction, while the MPEG-1 Video Standard only supports frame-based methodologies for DCT. A block coded by the field DCT method typically has a larger motion component than a block coded by the frame DCT method.

MPEG-4

The MPEG-4 standard is an Audiovisual (AV) encoder/decoder (codec) framework for creating and enabling interactivity with a wide set of tools for creating enhanced graphic content for objects organized in a hierarchical way for scene composition The MPEG-4 video standard was initiated in 1993 with the object of video compression and to provide a new generation of coded representations of a scene. For example, MPEG-4 encodes a scene as a collection of visual objects, where the objects (natural or synthetic) are individually coded and sent with the description of the scene for composition. Thus MPEG-4 relies on an object-based representation of a video data based on video object (VO) defined in MPEG-4, where each VO is characterized with properties such as shape, texture and motion. To describe the composition of these VOs to create audiovisual scenes, several VOs are then composed to form a scene with Binary Format for Scene (BIFS) enabling the modeling of any multimedia scenario as a scene graph where the nodes of the graph are the VOs. The BIFS describes a scene in the form a hierarchical structure, where the nodes may be dynamically added or removed from the scene graph on demand to provide interactivity, the mix/match of synthetic and natural audio or video, the manipulation/composition of objects that involves scaling, rotation, drag, drop and so forth. Therefore the MPEG-4 stream is composed of BIFS syntax, video/audio objects and other basic information such as synchronization configuration, decoder configurations and so on. Since BIFS contains information on the scheduling, coordinating in temporal and spatial domain, synchronization and processing interactivity, the client receiving the MPEG-4 stream needs to firstly decode the BIFS information that composes the audio/video ES. Based on the decoded BIFS information the decoder accesses the associated audio-visual data as well as other possible supplementary data. To apply MPEG-4 object-based representation to a scene, objects included in the scene should first be detected and segmented, which cannot be easily automated by using the current state-of-art image analysis technology.

H.264 (AVC)

H.264, also called Advanced Video Coding (AVC) or MPEG-4 part 10 is the newest international video coding standard. Video coding standards such as MPEG-2 enabled the transmission of HDTV (High Definition) signals over satellite, cable, and terrestrial emission, and the storage of HD video signals on various digital storage devices (such as disc drives, CDs, and DVDs). H.264 has arisen due to the need for improved coding efficiency over prior video coding standards such as MPEG-2.

Relative to prior video coding standards, H.264 has features that allow enhanced video coding efficiency. H.264 allows for variable block-size quarter-sample-accurate motion compensation, with block sizes as small as 4×4, allowing for more flexibility in the selection of motion compensation block size and shape over prior video coding standards.

H.264 has an advanced reference picture selection technique such that the encoder can select the pictures to be referenced for motion compensation compared to P- or B-pictures in MPEG-1 and MPEG-2 that may only reference a combination of an adjacent future and previous picture. Therefore H.264 provides a high degree of flexibility in the ordering of pictures for referencing and display purposes compared to the strict dependency between the ordering of pictures for motion compensation in the prior video coding standard.

Another technique of H.264 absent from other video coding standards is that H.264 allows the motion-compensated prediction signal to be weighted and offset by amounts specified by the encoder to improve the coding efficiency dramatically.

All major prior coding standards (such as JPEG, MPEG-1, MPEG-2) use a block size of 8×8 for transform coding, while the H.264 design uses a block size of 4×4 for transform coding. This allows the encoder to represent signals in a more adaptive way, enabling more accurate motion compensation and reducing artifacts. H.264 also uses two entropy coding methods, called Context-adaptive variable length coding (CAVLC) and Context-adaptive binary arithmetic coding (CABAC), using context-based adaptivity to improve the performance of entropy coding relative to prior standards.

H.264 also provides robustness to data error/losses for a variety of network environments. For example, a parameter set design provides for robust header information, which is sent separately for handling in a more flexible way to ensure that no severe impact in the decoding process is observed even if a few bits of information are lost during transmission. In order to provide data robustness H.264 partitions pictures into a group of slices where each slice may be decoded independent of other slices, similar to MPEG-1 and MPEG-2. However the slice structure in MPEG-2 is less flexible compared to H.264, reducing the coding efficiency due to the increasing quantity of header data and decreasing the effectiveness of prediction

In order to enhance the robustness, H.264 allows regions of a picture to be encoded redundantly such that if the primary information regarding a picture is lost, the picture can be recovered by receiving the redundant information on the lost region. Also H.264 separates the syntax of each slice into multiple different partitions depending on the importance of the coded information for transmission.

ATSC/DVB

The Advanced Television Systems Committee, Inc. (ATSC) is an international, non-profit organization developing voluntary standards for digital television (TV) including digital HDTV (high definition) and SDTV (standard definition). The ATSC digital TV standard, Revision B (ATSC Standard A/53B) defines a standard for digital video based on MPEG-2 encoding, and allows video frames as large as 1920×1080 pixels/pels (2,073,600 pixels) at 19.29 Mbps, for example. The Digital Video Broadcasting Project (DVB—an industry-led consortium of over 300 broadcasters, manufacturers, network operators, software developers, regulatory bodies and others in over 35 countries) provides a similar international standard for digital TV. Digitalization of cable, satellite and terrestrial television networks within Europe is based on the Digital Video Broadcasting (DVB) series of standards, while the United States and Korea utilize ATSC for digital TV broadcasting.

In order to view ATSC and DVB compliant digital streams, digital set top boxes (STBs), which may be connected inside or associated with user's TV set, began to penetrate TV markets. For purpose of this disclosure, the term STB is used to refer to any and all such display, memory, or interface devices intended to receive, store, process, repeat, edit, modify, display, reproduce or perform any portion of a program, including personal computer (PC) and mobile device. With this new consumer device, television viewers may record broadcast programs into the local or other associated data storage of their Digital Video Recorder (DVR) in a digital video compression format such as MPEG-2. A DVR is usually considered a STB having recording capability, for example in associated storage or in its local storage or hard disk. A DVR allows television viewers to watch programs in the way they want (within the limitations of the systems) and when they want (generally referred to as “on demand”). Due to the nature of digitally recorded video, viewers should have the capability of directly accessing a certain point of a recorded program (often referred to as “random access”) in addition to the traditional video cassette recorder (VCR) type controls such as fast forward and rewind.

Digital (video) signals differ from their analog (video) counterparts in two important ways. An analog signal is a continuously variable voltage or current, whereas a digital signal is represented by a limited number of discrete numerical values. The numerical values of the digital signal are obtained at specific instances in time (sampling points), whereas the analog signal is continuous in time. An analog-to-digital converter (ADC) performs the sampling of an analog signal to determine the discrete signal levels of the digital signal. Conversely, a digital-to-analog converter takes a digital signal and forms the analog counterpart. In general, the ADC and DAC have a sample clock to control the sampling rate or frequency.

Even though a digital signal is more robust than its analog counterpart with respect to noise, distortion, flutter, and cross-talk, system and component related issues can have an adverse affect on a digital signal. In a digital video system, the digital video signal is delayed due to the various system blocks in the system path. This delay is typically not constant, and variations in the delay are called jitter.

In a digital video system jitter (network jitter) can be introduced, amplified, accumulated, and attenuated as the digital video signal progresses through the various stages on its transmission path. Jitter acts to degrade the digital video signal in the system and can originate from connection losses, delays, noise and other spurious signals that are introduced in system blocks such as transmitters and receivers. Another type of jitter encountered in a digital video system is packet jitter caused by packet multiplexing of the transmitted digital video packets at the source, and the displacement of timestamp values within the signal stream. Jitter also refers to the variation (statistical dispersion) in the delay of packets because of internal queues and system components behavior.

As a general rule digital video signals require time alignment. For example, the video decoder and encoder clocks need to be aligned such that the video signal can be decoded and displayed in the correct time instants. This timing control is referred to as clock synchronization. The accumulation of jitter in the system has a direct and potentially adverse effect on clock synchronization. The end-to-end TS clock synchronization is a critical system requirement that ensures a constant end-to-end delay and prevents the overflow and underflow of internal media buffers. Additionally, the locking of the transmitter (Tx) and receiver (Rx) TS clocks have to comply with specific constraints regarding the allowed temporary clock drift in order to support the video color burst signal accuracy requirements of the video signal.

Two typical methods for video synchronization between transmitter and receiving terminals with transmitted packets are presented in “Transporting Compressed Digital Video” (Kluwer Academic Publishers 2002) by Xuemin Chen.

The first method (FIG. 1A) of video synchronization measures the fullness of the buffer at the receiver to control the decoder clock. The receiver 100 collects transmitted packets 102 in a buffer 104, while a digital phase-locked-loop (D-PLL) 108 monitors the buffer 104 via a buffer fullness signal 106. When the buffer 104 reaches a predefined level of transmitted packets 102, the D-PLL 108 sends a control signal 110 to the decoder clock 112 that supplies a clock signal 114 to regulate the video decoder 116 and its rate of decoded video 118. If the level of packets 102 in the buffer 104 exceeds a predefined value, the D-PLL 108 instructs the decoder clock 112 to increase the rate of operation of the video decoder 114 in order to decrease the level of stored packets 102 within the buffer 104. If the level of stored packets 102 within buffer 104 is lower than the predefined value, the D-PLL 108 instructs the decoder clock 112 to decrease the rate of operation of the video decoder 116 in order to increase the level of stored packets 102 within the buffer 104.

The second method (FIG. 1B) of video synchronization utilizes time reference stamps inserted into the packet stream at the transmitter encoder. The receiver 100 collects transmitted packets 102 in a buffer 104, while a digital phase-locked-loop (D-PLL) 108 monitors the time reference stamps via the time stamp detector 107. The D-PLL 108 sends a control signal 110 to the decoder clock 112 to keep the time difference between the time reference stamps and the actual arrival time at a constant value. The decoder clock 112 supplies a clock signal 114 to regulate the video decoder 116 and its rate of decoded video 118. As was mentioned previously in our discussion the MPEG-2 Transport Stream there are explicit timestamps referred to as Program Clock References (PCR) within the video packets that facilitate clock recovery.

The two methods for video synchronization between transmitter and receiving terminals with transmitted packets previously discussed have defects that are addressed by the novel invention of this disclosure. The first method employing buffer fullness has been found to produce noisy phase estimates entering the PLL, with a resultant poor quality signal output. With regards to the second approach the use of PCR's is well known in the art and is in fact part of the MPEG standard. However, in applications of the present invention the encountered network jitter is much larger and requires a more robust approach to address the jitter. Therefore, the present invention introduces an additional layer of timestamps (in addition to the MPEG PCR's), as well as, further mathematical analysis of the stream of timestamp packets.

Glossary

Unless otherwise noted, or as may be evident from the context of their usage, any terms, abbreviations, acronyms or scientific symbols and notations used herein are to be given their ordinary meaning in the technical discipline to which the disclosure most nearly pertains. The following terms, abbreviations and acronyms may be used in the description contained herein:

API—An application programming interface (API) is the interface that a computer system, library, or application provides in order to allow requests for services to be made of it by other computer programs, and/or to allow data to be exchanged between them.

ATSC—Advanced Television Systems Committee, Inc. (ATSC) is an international, non-profit organization developing voluntary standards for digital television. Countries such as U.S. and Korea adopted ATSC for digital broadcasting. A more extensive explanation of ATSC may be found in “ATSC Standard A/53C with Amendment No. 1: ATSC Digital Television Standard, Rev. C,” (see World Wide Web at atsc.org). More description may be found in “Data Broadcasting: Understanding the ATSC Data Broadcast Standard” (McGraw-Hill Professional, April 2001) by Richard S. Chernock, Regis J. Crinon, Michael A. Dolan, Jr., John R. Mick; and may also be available in “Digital Television, DVB-T COFDM and ATSC 8-VSB” (Digitaltvbooks.com, October 2000) by Mark Massel. Alternatively, Digital Video Broadcasting (DVB) is an industry-led consortium committed to designing global standards that were adopted in European and other countries, for the global delivery of digital television and data services.

AV—Audiovisual

AVC—Advanced Video Coding (H.264) is newest video coding standard of the ITU-T Video Coding Experts Group and the ISO/IEC Moving Picture Experts Group. An explanation of AVC may be found in “Overview of the H.264/AVC video coding standard”, Wiegand, T., Sullivan, G. J., Bjntegaard, G., Luthra, A., Circuits and Systems for Video Technology, IEEE Transactions on, Volume: 13, Issue: 7, July 2003, Pages: 560-576; another may be found in “ISO/IEC 14496-10: Information technology—Coding of audio-visual objects—Part 10. Advanced Video Coding” (see World Wide Web at iso.org); Yet another description is found in “H.264 and MPEG-4 Video Compression” (Wiley) by Iain E. G. Richardson, all three of which are incorporated herein by reference. MPEG-1 and MPEG-2 are alternatives or adjunct to AVC and are considered or adopted for digital video compression.

BIFS—Binary Format for Scene is a scene graph in the form of hierarchical structure describing how the video objects should be composed to form a scene in MPEG-4. A more extensive information of BIFS may be found in “H.264 and MPEG-4 Video Compression” (John Wiley & Sons, August, 2003) by Iain E. G. Richardson and “The MPEG-4 Book” (Prentice Hall PTR, July, 2002) by Touradj Ebrahimi, Fernando Pereira.

Codec—enCOder/DECoder is a short word for the encoder and the decoder. The encoder is a device that encodes data for the purpose of achieving data compression. Compressor is a word used alternatively for encoder. The decoder is a device that decodes the data that is encoded for data compression. Decompressor is a word alternatively used for decoder. Codecs may also refer to other types of coding and decoding devices.

DCT—Discrete Cosine Transform (DCT) is a transform function from spatial domain to frequency domain, a type of transform coding. A more extensive explanation of DCT may be found in “Discrete-Time Signal Processing” (Prentice Hall, 2nd edition, February 1999) by Alan V. Oppenheim, Ronald W. Schafer, John R. Buck. Wavelet transform is an alternative or adjunct to DCT for various compression standards such as JPEG-2000 and Advanced Video Coding. A more thorough description of wavelet may be found in “Introduction on Wavelets and Wavelets Transforms” (Prentice Hall, 1st edition, August 1997)) by C. Sidney Burrus, Ramesh A. Gopinath. DCT may be combined with Wavelet, and other transformation functions, such as for video compression, as in the MPEG 4 standard, more fully described in “H.264 and MPEG-4 Video Compression” (John Wiley & Sons, August 2003) by Iain E. G. Richardson and “The MPEG-4 Book” (Prentice Hall, July 2002) by Touradj Ebrahimi, Fernando Pereira.

DTV—Digital Television (DTV) is an alternative audio-visual display device augmenting or replacing current analog television (TV) characterized by receipt of digital, rather than analog, signals representing audio, video and/or related information. Video display devices include Cathode Ray Tube (CRT), Liquid Crystal Display (LCD), Plasma and various projection systems. Digital Television is more fully described in “Digital Television: MPEG-1, MPEG-2 and Principles of the DVB System” (Butterworth-Heinemann, June, 1997) by Herve Benoit.

DVB—Digital Video Broadcasting is a specification for digital television broadcasting mainly adopted in various countries in Europe. A more extensive explanation of DVB may be found in “DVB: The Family of International Standards for Digital Video Broadcasting” by Ulrich Reimers (see World Wide Web at dvb.org). ATSC is an alternative or adjunct to DVB and is considered or adopted for digital broadcasting used in many countries such as the U.S. and Korea.

DVD—Digital Video Disc (DVD) is a high capacity CD-size storage media disc for video, multimedia, games, audio and other applications. A more complete explanation of DVD may be found in “An Introduction to DVD Formats” (see disctronics.co.uk/downloads/tech_docs/dvdintroduction.pdf) and “Video Discs Compact Discs and Digital Optical Discs Systems” (Information Today, June 1985) by Tony Hendley. CD (Compact Disc), minidisk, hard drive, magnetic tape, circuit-based (such as flash RAM) data storage medium are alternatives or adjuncts to DVD for storage, either in analog or digital format.

DVR—Digital Video Recorder (DVR) is usually considered a STB having recording capability, for example in associated storage or in its local storage or hard disk. A more extensive explanation of DVR may be found in “Digital Video Recorders: The Revolution Remains on Pause” (MarketResearch.com, April 2001) by Yankee Group.

ES—Elementary Stream (ES) is a stream containing either video or audio data with a sequence header and subparts of a sequence. A more extensive explanation of ES may be found in “Generic Coding of Moving Pictures and Associated Audio Information—Part 1: Systems,” ISO/IEC 13818-1 (MPEG-2), 1994 (http://iso.org).

FCC—The Federal Communications Commission (FCC) is an independent United States government agency, directly responsible to Congress. The FCC was established by the Communications Act of 1934 and is charged with regulating interstate and international communications by radio, television, wire, satellite and cable. More information can be found at their website (see World Wide Web at fcc.gov/aboutus.html).

F/W—Firmware (F/W) is a combination of hardware (H/W) and software (S/W), for example, a computer program embedded in state memory (such as a Programmable Read Only Memory (PROM)) which can be associated with an electrical controller device (such as a microcontroller or microprocessor) to operate (or “run) the program on an electrical device or system. A more extensive explanation may be found in “Embedded Systems Firmware Demystified” (CMP Books 2002) by Ed Sutter.

HDTV—High Definition Television (HDTV) is a digital television or monitor which provides superior digital picture quality (resolution). The 1080i (1920×1089 pixels interlaced), 1080p (1920×1080 pixels progressive) and 720p (1280×720 pixels progressive) formats in a 16:9 aspect ratio are the commonly adopted HDTV formats. The “interlaced” or “progressive” refers to the scanning mode of HDTV which are explained in more detail in “ATSC Standard A/53C with Amendment No. 1: ATSC Digital Television Standard”, Rev. C, 21 May 2004 (see World Wide Web at atsc.org).

Huffman Coding—Huffman coding is a data compression method which may be used alone or in combination with other transformation functions or encoding algorithms (such as DCT, Wavelet, and others) in digital imaging and video as well as in other areas. A more extensive explanation of Huffman coding may be found in “Introduction to Data Compression” (Morgan Kaufmann, Second Edition, February, 2000) by Khalid Sayood.

H/W—Hardware (H/W) is the physical components of an electronic or other device. A more extensive explanation on H/W may be found in “The Hardware Cyclopedia” (Running Press Book, 2003) by Steve Ettlinger.

IEEE—Abbreviation of Institute of Electrical and Electronics Engineers, pronounced I-triple-E. Founded in 1884 as the AIEE, the IEEE was formed in 1963 when AIEE merged with IRE. IEEE is an organization composed of engineers, scientists, and students. The IEEE is best known for developing standards for the computer and electronics industry. In particular, the IEEE 802 standards for local-area networks are widely followed.

JPEG—JPEG (Joint Photographic Experts Group) is a standard for still image compression. A more extensive explanation of JPEG may be found at “ISO/IEC International Standard 10918-1” (see World Wide Web at jpeg.org/jpeg/). Various MPEG, Portable Network Graphics (PNG), Graphics Interchange Format (GIF), XBM (X Bitmap Format), Bitmap (BMP) are alternatives or adjuncts to JPEG and is considered or adopted for various image compression(s).

LAN—Local Area Network (LAN) is a data communication network spanning a relatively small area. Most LANs are confined to a single building or group of buildings. However, one LAN can be connected to other LANs over any distance, for example, via telephone lines and/or radio frequency (RF) transmission to form a Wide Area Network (WAN). More information can be found in “Ethernet: The Definitive Guide” (O'Reilly& Associates) by Charles E. Spurgeon.

MHz (Mhz)—A measure of signal frequency expressing millions of cycles per second.

MPEG—The Moving Picture Experts Group is a standards organization dedicated primarily to digital motion picture encoding in Compact Disc. Additional information is available at MPEG web site (please consult World Wide Web at mpeg.org).

MPEG-2—Moving Picture Experts Group-Standard 2 (MPEG-2) is a digital video compression standard designed for coding interlaced and non-interlaced frames. MPEG-2 is currently used for DTV broadcast and DVD. A more extensive explanation of MPEG-2 may be found on the World Wide Web at mpeg.org and in “Digital Video: An Introduction to MPEG-2 (Digital Multimedia Standards Series)” (Springer, 1996) by Barry G. Haskell, Atul Puri, Arun N. Netravali.

MPEG-4—Moving Picture Experts Group-Standard 4 (MPEG-4) is a video compression standard supporting interactivity by allowing authors to create and define the media objects in a multimedia presentation, how these can be synchronized and related to each other in transmission, and how users are to be able to interact with the media objects. More extensive information about MPEG-4 can be found in “H.264 and MPEG-4 Video Compression” (John Wiley & Sons, August, 2003) by Iain E. G. Richardson and “The MPEG-4 Book” (Prentice Hall PTR, July, 2002) by Touradj Ebrahimi, Fernando Pereira.

MPEG-7—Moving Picture Experts Group-Standard 7 (MPEG-7), formally named “Multimedia Content Description Interface” (MCDI) is a standard for describing the multimedia content data. More extensive information about MPEG-7 can be found at the MPEG home page (http://mpeg.tilab.com), the MPEG-7 Consortium website (see World Wide Web at mp7c.org), and the MPEG-7 Alliance website (see World Wide Web at mpeg-industry.com) as well as “Introduction to MPEG 7: Multimedia Content Description Language” (John Wiley & Sons, June, 2002) by B. S. Manjunath, Philippe Salembier, and Thomas Sikora, and “ISO/IEC 15938-5:2003 Information technology—Multimedia content description interface—Part 5. Multimedia description schemes” (see World Wide Web at iso.ch).

NTSC—The National Television System Committee (NTSC) is responsible for setting television and video standards in the United States (in Europe and the rest of the world, the dominant television standards are PAL and SECAM). More information is available by viewing the tutorials on the World Wide Web at ntsc-tv.com.

PCR—Program Clock Reference (PCR) in the Transport Stream (TS) indicates the sampled value of the system time clock that can be used for the correct presentation and decoding time of audio and video. A more extensive explanation of PCR may be found in “Generic Coding of Moving Pictures and Associated Audio Information—Part 1. Systems,” ISO/IEC 13818-1 (MPEG-2), 1994 (http://iso.org). SCR (System Clock Reference) is an alternative or adjunct to PCR used in MPEG program streams.

PES—Packetized Elementary Stream (PES) is a stream composed of a PES packet header followed by the bytes from an Elementary Stream (ES). A more extensive explanation of PES may be found in “Generic Coding of Moving Pictures and Associated Audio Information—Part 1: Systems,” ISO/IEC 13818-1 (MPEG-2), 1994 (http://iso.org).

Phase-Locked Loop—In electronics, a phase-locked loop (PLL) is a closed-loop feedback control system that maintains a generated signal in a fixed phase relationship to a reference signal.

PHY—PHY is a generic electronics term referring to a special electronic integrated circuit or functional block of a circuit that takes care of encoding and decoding between a pure digital domain (on-off) and a modulation in the analog domain.

PID—A Packet Identifier (PID) is a unique integer value used to identify Elementary Streams (ES) of a program or ancillary data in a single or multi-program Transport Stream (TS). A more extensive explanation of PID may be found in “Generic Coding of Moving Pictures and Associated Audio Information—Part 1. Systems,” ISO/IEC 13818-1 (MPEG-2), 1994 (http://iso.org).

PS—Program Stream (PS), specified by the MPEG-2 System Layer, is used in relatively error-free environment such as DVD media. A more extensive explanation of PS may be found in “Generic Coding of Moving Pictures and Associated Audio Information—Part 1: Systems,” ISO/IEC 13818-1 (MPEG-2), 1994 (http://iso.org).

PTS—Presentation Time Stamp (PTS) is a time stamp that indicates the presentation time of audio and/or video. A more extensive explanation of PTS may be found in “Generic Coding of Moving Pictures and Associated Audio Information—Part 1: Systems,” ISO/IEC 13818-1 (MPEG-2), 1994 (http://iso.org).

PVR—Personal Video Recorder (PVR) is a term that is commonly used interchangeably with DVR.

Quality of Service—In the fields of packet-switched networks and computer networking, the traffic engineering term Quality of Service (QoS, pronounced “queue-oh-ess”) refers to the probability of the telecommunication network meeting a given traffic contract, or in many cases is used informally to refer to the probability of a packet succeeding in passing between two points in the network.

RF—Radio Frequency (RF) refers to any frequency within the electromagnetic spectrum associated with radio wave propagation.

SCR—System Clock Reference (SCR) in the Program Stream (PS) indicates the sampled value of the system time clock that can be used for the correct presentation and decoding time of audio and video. A more extensive explanation of SCR may be found in “Generic Coding of Moving Pictures and Associated Audio Information—Part 1: Systems,” ISO/IEC 13818-1 (MPEG-2), 1994 (http://iso.org). PCR (Program Clock Reference) is an alternative or adjunct to SCR.

SDTV—Standard Definition Television (SDTV) is one mode of operation of digital television that does not achieve the video quality of HDTV, but are at least equal, or superior to, NTSC pictures. SDTV may usually have either 4:3 or 16:9 aspect ratios, and usually includes surround sound. Variations of frames per second (fps), lines of resolution and other factors of 480p and 480i make up the 12 SDTV formats in the ATSC standard. The 480p and 480i each represent 480 progressive and 480 interlaced format explained in more detail in ATSC Standard A/53C with Amendment No. 1: ATSC Digital Television Standard, Rev. C 21 May 2004 (see World Wide Web at atsc.org).

Space-time block coding—space-time block coding is a technique used in wireless communications to transmit multiple copies of a data stream across a number of antennas and to exploit the various received versions of the data to improve the reliability of data-transfer. The fact that transmitted data must traverse a potentially difficult environment with scattering, reflection, refraction and so on as well as be corrupted by thermal noise in the receiver means that some of the received copies of the data will be ‘better’ than others. This redundancy results in a higher chance of being able to use one or more of the received copies of the data to correctly decode the received signal. In fact, space-time coding combines all the copies of the received signal in an optimal way to extract as much information from each of them as possible.

STB—Set-top Box (STB) is a display, memory, or interface device intended to receive, store, process, repeat, edit, modify, display, reproduce or perform any portion of a program, including personal computer (PC) and mobile device.

SAN—Software is a computer program or set of instructions which enable electronic devices to operate or carry out certain activities. A more extensive explanation of S/W may be found in “Concepts of Programming Languages” (Addison Wesley) by Robert W. Sebesta.

TS—Transport Stream (TS), specified by the MPEG-2 System layer, is used in environments where errors are likely, for example, broadcasting networks. TS packets into which PES packets are further packetized are 188 bytes in length. An explanation of TS may be found in “Generic Coding of Moving Pictures and Associated Audio Information—Part 1: Systems,” ISO/IEC 13818-1 (MPEG-2), 1994 (http://iso.org).

TV—Television, generally a picture and audio presentation or output device; common types include cathode ray tube (CRT), plasma, liquid crystal, and other projection and direct view systems, usually with associated speakers.

VCO—A voltage-controlled oscillator or VCO is an electronic oscillator specifically designed to be controlled in oscillation frequency by a voltage input. The frequency of oscillation, or rate of repetition, is varied with an applied DC voltage, while modulating signals may be fed into the VCO to generate frequency modulation (FM) or phase modulation (PM).

VCR—Video Cassette Recorder (VCR) A DVR is an alternative or adjunct to a VCR.

VCXO—A voltage-controlled crystal oscillator (VCXO) is used when the frequency of operation needs to be adjusted by a relatively small amount, or when exact frequency or phase of the oscillator is critical, or, by applying a varying voltage to the control input of the oscillator, to disperse radio-frequency interference over a range of frequencies to make it less objectionable. Typically the frequency of a voltage-controlled crystal oscillator can only be varied by a few tens of parts per million (ppm), because the high Q factor of the crystals allows only a small “pulling” range of frequencies to be produced.

WAN—A Wide Area Network (WAN) is a network that spans a wider area than does a Local Area Network (LAN). More information can be found by in “Ethernet: The Definitive Guide” (O'Reilly& Associates) by Charles E. Spurgeon

### SUMMARY OF THE INVENTION

There is provided, in accordance with some embodiments of the present invention, a system, method and circuit for clock recovery and synchronization in wireless media streaming. More specifically the adverse affect of jitter on the recovery of a wirelessly transmitted MPEG2 Transport Stream (TS) signal at a receiver is addressed through the implementation of algorithms (mathematical analysis and formulas) for accurate clock frequency and phase error estimation, based on real-time statistical evaluation of data at the receiver. The clock frequency and clock phase error estimation are achieved with an Envelope Set Building Algorithm based on real time samples of jitter values. Additional timing signals at the transmitter are also introduced to aid in signal synchronization.

According to some embodiments of the present invention, the media transmitter/transceiver may be adapted to transmit content bearing data from a media source to a media receiver functionally associated with a presentation device. The content bearing data may be a compressed media file stored on a source device's non-volatile memory, DVD, VHS, or other storage medium, or a live broadcast signal transmitted via cable or satellite. For purposes of this application, any of the above mentioned content bearing data, or any other data types which may be transmitted, received, and presented in accordance with any aspect of the present invention, may be referred to as: (1) content bearing data, (2) content bearing data stream, (3) media stream, or (4) any other term which would be understood by one of ordinary skill in the art at the time the present application is filed.

The present invention performs short distance wireless transmission using MPEG video compression and WLAN transmission technologies. However, WLAN was designed for data transfer and not the transmission of video. Packet error jitter introduced by the WLAN can range from 10 msec and approach 100 msec. The MPEG decoder requires jitter to be kept in the range of 1 to 30 μsec, which is several orders of magnitude less. Such high jitter levels cause the MPEG decoder to lose signal lock, and disrupt a displayed image. In addition, WLAN does not meet the quality of service (QoS) demanded by video applications. New high definition (HD) displays demand a high quality video signal. System delay techniques to compensate for transmission issues, such as excessive buffering are not acceptable to the viewer. Consumers expect agile channel response during channel/program searches, with delays of under 1 sec and preferably less than 0.5 sec between displayed channels. The present novel invention compensates for the WLANs lack of video performance, and in essence provides the receiver MPEG decoder with the equivalent signal quality of a wired connection to the MPEG encoder at the transmitter.

The present invention achieves the low level of jitter despite the use of the WLAN connection by implementing packets that are just time stamps. These time stamp packets are independent and in addition to the Program Clock Reference (PCR) in the Transport Stream (TS) of the MPEG2 signal, and are used to create the recovered clock at the receiver. The time stamp packets have a special transmit queue, and receive a higher priority than other packets to reduce jitter. There is no retransmission of the time stamp packets, which is another factor in controlling jitter. In addition, the time stamp packets are given order. The receiver checks if the packets are received in proper order, and special processing is done to either determine proper order of the packets, or to drop out of sequence packets. Fast interrupt processing at the receiver also contributes to a lower level of jitter. Algorithms (mathematical analysis and formulas) are implemented for accurate clock frequency and phase error estimation, based on real-time statistical evaluation of data at the receiver. The clock frequency and phase error estimation are achieved with an Envelope Set Building Algorithm based on real time samples of jitter values. The novel Envelope Building Algorithm differs from current methods that only use arithmetic averaging. The estimated clock frequency and clock phase errors are used to compute an updated control voltage for the clock source. It should also be noted that other video compression methods besides MPEG2 can be used in the context of the novel invention of this disclosure. Therefore, the broad term ‘video compression’ will be used throughout the disclosure.

These and other objects, features, and advantages of the present invention will no doubt become apparent to those of ordinary skill in the art after reading the following detailed description of the preferred embodiments that are illustrated in the various figures and drawings.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A shows a functional block diagram of a receiver decoder utilizing buffer fullness to achieve video synchronization according to the prior art.

FIG. 1B shows a functional block diagram of a receiver decoder utilizing time stamps to achieve video synchronization according to the prior art.

FIG. 2A is diagram showing an exemplary system arrangement of media related devices, according to some embodiments of the present invention, wherein a multimedia device is connected to a wireless transmitter block of the present invention, and a wireless receiver block of the present invention is connected to a display device.

FIG. 2B is diagram showing an exemplary system arrangement of media related devices, according to some embodiments of the present invention, wherein a multimedia device has an embedded wireless transmitter block of the present invention, and the wireless receiver block of the present invention is embedded in a display device.

FIG. 3A is a block diagram illustrating the stages that comprise the wireless transmitter block of the present invention including an audio/video interface, video compression encoder, TX Video QoS Engine, and Wireless transmitter.

FIG. 3B is a block diagram illustrating the stages that comprise the wireless receiver block of the present invention including a Wireless receiver, RX Video QoS Engine, video compression decoder, and audio/video interface.

FIG. 3C is a block diagram illustrating the stages that comprise an alternative embodiment of the wireless transmitter block of the present invention in which the audio/video interface and video compression encoder are not required.

FIG. 3D is a block diagram illustrating the stages that comprise an alternative embodiment of the wireless receiver block of the present invention in which the video compression decoder and audio/video interface are not required.

FIG. 4 is a functional block diagram of the video QoS engine configured for the transmit mode and its placement in a transmit configuration of FIG. 3A, in accordance with some embodiments of the present invention.

FIG. 5 is a functional block diagram of the video QoS engine configured for the receive mode and its placement in a receive configuration of FIG. 3B, in accordance with some embodiments of the present invention.

FIG. 6 is a functional block diagram of the Clock Control Algorithm of the video QoS engine configured for the receive mode of FIG. 5. The Clock Control Algorithm is comprised of the Clock Messages Processing Block, Error Estimation Block, and the Control Value Correction Block, in accordance with some embodiments of the present invention.

FIG. 7 is a functional block diagram of the Clock Messages Block of FIG. 6, and its interrelation to the Error Estimation block and the Control Value Correction Block, in accordance with some embodiments of the present invention.

FIG. 8 is a representation of the components of a Clock Control Message that is an input to the Clock Control Algorithm Block, in accordance with some embodiments of the present invention.

FIG. 9 is a functional block diagram of the Error Estimation Block of FIG. 6 that is comprised of Phase Error Normalization stage, an Envelope Set Building Bock, and a Frequency and Phase Error Estimation stage, in accordance with some embodiments of the present invention.

FIG. 10 is a synthetic graph of error samples with the Sample Envelope outlined, in accordance with some embodiments of the present invention.

FIG. 11 illustrates the determination of Frequency Error Estimation based on the slope of the Sample Envelope of the graph in FIG. 10, in accordance with some embodiments of the present invention.

FIG. 12 is a functional block diagram of the Control Value Correction Block of FIG. 6 that is comprised of Control Value Correction Computing, Control Value Limiter, and Control Value Scaler stages, in accordance with some embodiments of the present invention.

FIG. 13 illustrates an example of a Voltage Controlled Crystal Oscillator (VCXO) characteristic curve for the transformation of ppm to Control Value, in accordance with some embodiments of the present invention.

FIG. 14 illustrates an example graph of a Frequency Correction Function, in accordance with some embodiments of the present invention.

FIG. 15 illustrates an example graph of a Phase Correction Function, in accordance with some embodiments of the present invention.

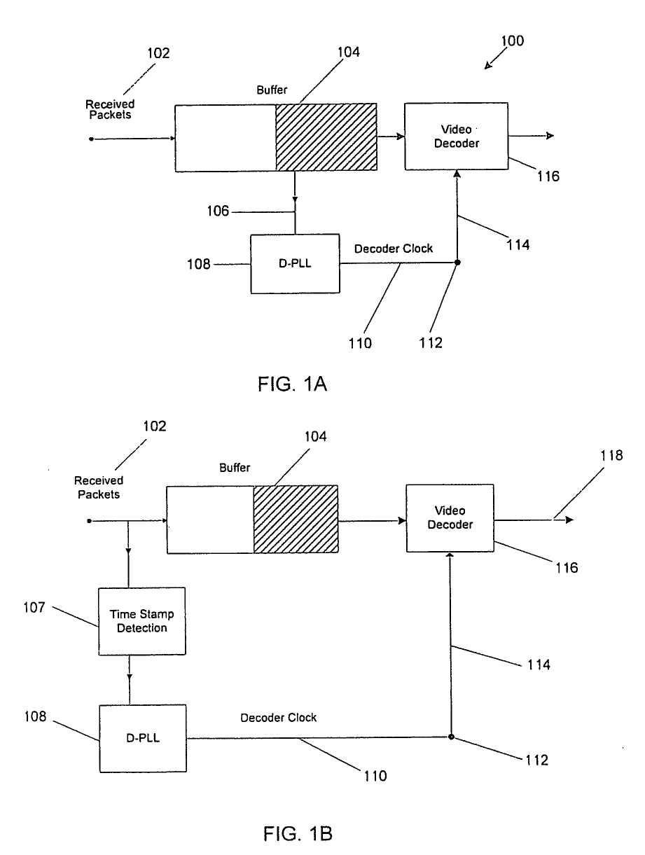

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

There is provided, in accordance with some embodiments of the present invention, a system, method and circuit for clock recovery and synchronization in wireless media streaming. More specifically the adverse affect of jitter on the recovery of a wirelessly transmitted MPEG2 Transport Stream (TS) signal at a receiver is addressed through the implementation of algorithms (mathematical analysis and formulas) for accurate clock frequency and phase error estimation, based on real-time statistical evaluation of data at the receiver. The clock frequency and clock phase error estimation are achieved with an Envelope Set Building Algorithm based on real time samples of jitter values. Additional timing signals at the transmitter are also introduced to aid in signal synchronization.

According to some embodiments of the present invention, the media transmitter/transceiver may be adapted to transmit content bearing data from a media source to a media receiver functionally associated with a presentation device. The content bearing data may be a compressed media file stored on a source device's non-volatile memory, DVD, VHS, or other storage medium, or a live broadcast signal transmitted via cable or satellite. For purposes of this application, any of the above mentioned content bearing data, or any other data types which may be transmitted, received, and presented in accordance with any aspect of the present invention, may be referred to as: (1) content bearing data, (2) content bearing data stream, (3) media stream, or (4) any other term which would be understood by one of ordinary skill in the art at the time the present application is filed.

The present invention performs short distance wireless transmission using MPEG video compression and WLAN transmission technologies. However, WLAN was designed for data transfer and not the transmission of video. Packet error jitter introduced by the WLAN can range from 10 msec and approach 100 msec. The MPEG decoder requires jitter to be kept in the range of 1 to 30 μsec, which is several orders of magnitude less. Such high jitter levels cause the MPEG decoder to lose signal lock, and disrupt a displayed image. In addition, WLAN does not meet the quality of service (QoS) demanded by video applications. New high definition (HD) displays demand a high quality video signal. System delay techniques to compensate for transmission issues, such as excessive buffering are not acceptable to the viewer. Consumers expect agile channel response during channel/program searches, with delays of under 1 sec and preferably less than 0.5 sec between displayed channels. The present novel invention compensates for the WLANs lack of video performance, and in essence provides the receiver MPEG decoder with the equivalent signal quality of a wired connection to the MPEG encoder at the transmitter.

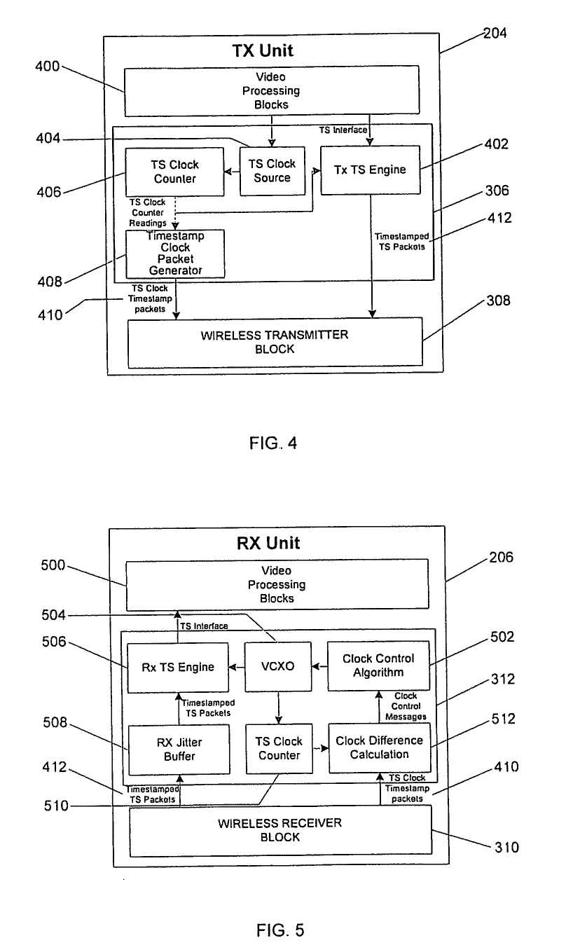

The present invention achieves the low level of jitter despite the use of the WLAN connection. WLAN implementations may have multiple transmit queues, of packets waiting to be transmitted, with different priorities for the different queues, and transmitter jitter is due to these variable delays. The transmit jitter can be mitigated by implementing packets that are just time stamps (Please see FIG. 4, TS Clock Timestamp packets 410). The TS Clock Timestamp packets 410 are independent and in addition to the Program Clock Reference (PCR) in the Transport Stream (TS) of the MPEG2 signal, and are used to create the recovered clock at the receiver. The TS Clock Timestamp packets 410 have a special transmit queue, and receive a higher priority than other packets to reduce jitter. There is no retransmission of the TS Clock Timestamp packets 410, which is another factor in controlling jitter. In addition, the TS Clock Timestamp packets 410 are given order. The receiver checks if the TS Clock Timestamp packets 410 are received in proper order, and special processing is done to either determine proper order of the packets, or to drop out of sequence packets. Fast interrupt processing at the receiver also contributes to a lower level of jitter. Optionally, to reduce transmit jitter on the TS Clock Timestamp packets 410, the timestamp message is prepared in advance, and the actual value of timestamp is inserted into the message, just before the WLAN transmits this message. (I.e. all the fields of the message except for the timestamp itself are prepared in advance). Alternatively, to reduce Tx jitter, the transmit queue (or queues) of the WLAN is monitored, and when a situation of an empty transmit queue (or queues) arises, a TS Clock Timestamp packet 410 is prepared and sent. In yet another alternative implementation, whenever a TS Clock Timestamp packet 410 is prepared, it is automatically placed at the head of the queue. Algorithms (mathematical analysis and formulas) are implemented for accurate clock frequency and phase error estimation, based on real-time statistical evaluation of data at the receiver. The clock frequency and clock phase error estimation are achieved with an Envelope Set Building Algorithm based on real time samples of jitter values. The novel Envelope Building Algorithm differs from current methods that only use arithmetic averaging. The estimated clock frequency and clock phase errors are used to compute an updated control voltage for the clock source.

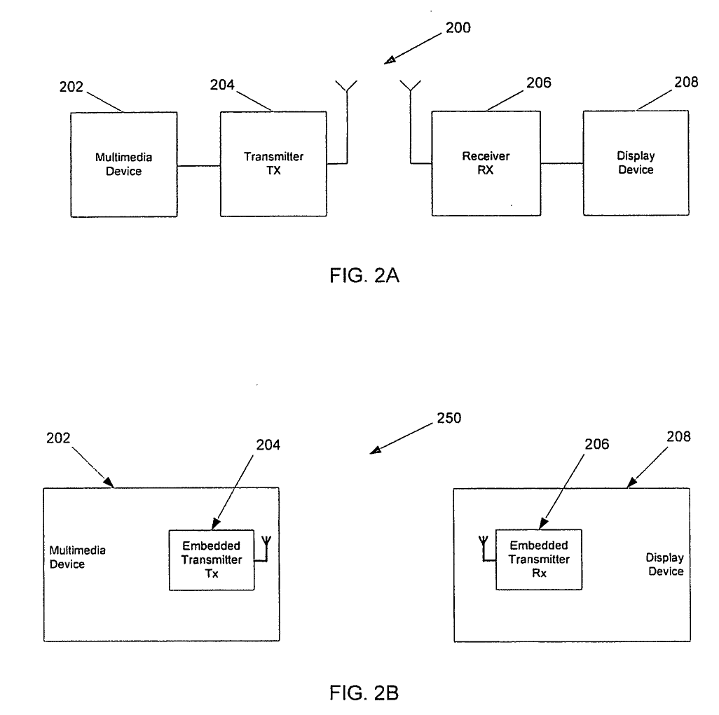

Turning now to FIG. 2A, there is shown a diagram of an exemplary system 200 arrangement of media related devices, according to some embodiments of the present invention, wherein a multimedia device 202 is connected to a wireless transmitter block 204 of the present invention, and a wireless receiver block 206 of the present invention is connected to a display device 208. The multimedia device 202 may include (but is not limited to) a DVD, DVR, or VHS player with prerecorded content, or a STB relaying real-time media content. The wireless transmitter block 204 transmits a RF signal composed of information content from the multimedia device 202 to the wireless receiver block 206. The wireless receiver block 206 supplies the information content that originated from the multimedia device 202 to the display device 208. The display device 208 can take many forms including (but is not limited to) an analog TV, SDTV, HDTV, or a monitor.

FIG. 2B is a diagram of an exemplary system 250 arrangement of media related devices, according to some embodiments of the present invention, wherein a multimedia device 202 has the wireless transmitter block 204 of the present invention embedded, and a wireless receiver block 206 of the present invention is embedded in a display device 208. The multimedia device 202 may include (but is not limited to) a DVD, DVR, or VHS player with prerecorded content, or a STB relaying real-time media content. The embedded wireless transmitter block 204 transmits a RF signal composed of information content from the multimedia device 202 to the wireless receiver block 206 embedded in display device 208. The embedded wireless receiver block 206 supplies the information content that originated from the multimedia device 202 to the display device 208. The display device 208 can take many forms including (but is not limited to) an analog TV, SDTV, HDTV, or a monitor. By embedding the wireless transmitter block 204 and/or wireless receiver block 206, additional external connections are avoided, which results in the elimination of extra external wires or cabling. The elimination of external connections contributes to a neater and more reliable system. It should be understood that embedded transmitters can work with non-embedded receivers, or vice versa.

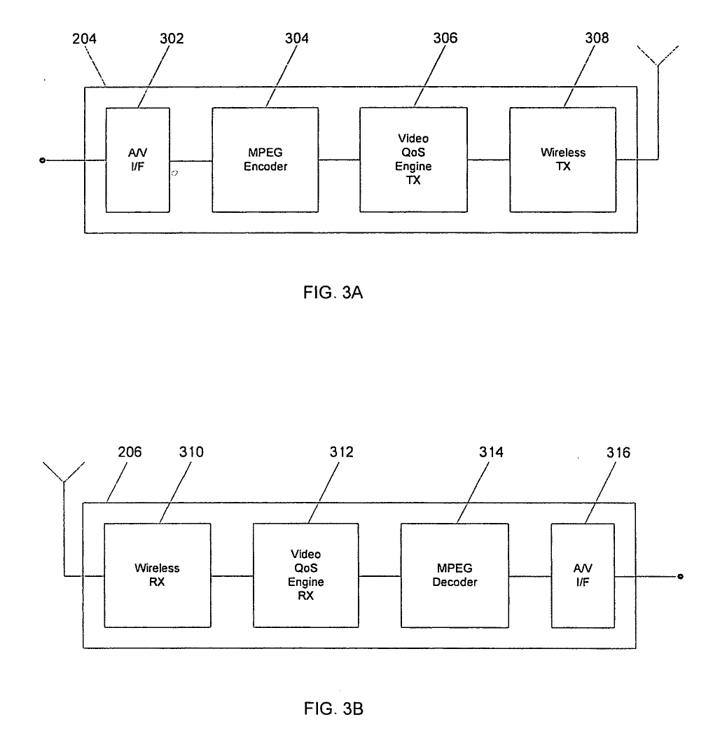

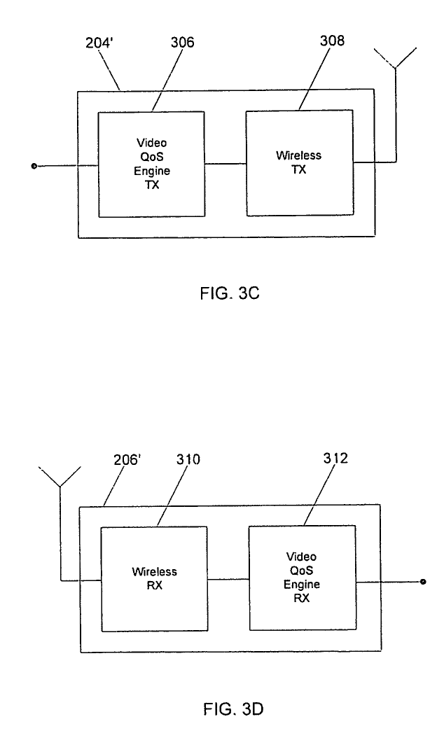

FIG. 3A is a block diagram illustrating the stages that comprise the wireless transmitter block 204 of the present invention including an audio/video interface 302, video compression encoder 304, TX Video QoS Engine 306, and Wireless Transmitter 308. The input audio/video interface 302 provides connection points to receive the information content from the multimedia device 202, and converts the signal into a format suitable for the video compression encoder 304. The video compression encoder 304 compresses the signal, which is then presented to the TX Video QoS Engine 306. The TX Video QoS Engine 306 serves as an interface between the video compression encoder 304 and the Wireless Transmitter 308. The TX Video QoS Engine 306 performs additional processing on the signal that is the subject of this disclosure, and will be developed in greater detail shortly. The Wireless Transmitter 308 can be made of 802.11a/b/g wireless chipsets, or chipsets of the emerging 802.11n, H.264 and UWB standards.

FIG. 3B is a block diagram illustrating the stages that comprise the wireless receiver block 206 of the present invention including a Wireless Receiver 310, RX video QoS engine 312, video compression decoder 314, and output audio/video interface 316. The Wireless Receiver 310 receives the wireless signal from the wireless transmitter block 204, and passes the signal to the RX video QoS engine 312. The RX Video QoS Engine 312 performs additional processing on the signal that is the subject of this disclosure, and will be developed in greater detail shortly. The RX Video QoS Engine 312 passes the signal to the video compression decoder 314. The video compression decoder 314 decompresses the compressed signal and passes the signal along to the output audio/video interface 316. The output audio/video interface 316 provides connection points to the display device 208.

FIG. 3C is a block diagram illustrating the stages that comprise the wireless transmitter block 204′, an alternative embodiment of the present invention, including a TX Video QoS Engine 306, and Wireless Transmitter 308. The audio/video interface 302, video compression encoder 304 are eliminated since the media input is already in a compressed video format. The wireless transmitter block 204′ would generally be used in the embedded context of FIG. 2B.

FIG. 3D is a block diagram illustrating the stages that comprise the wireless receiver block 206′, an alternative embodiment of the present invention, including a Wireless Receiver 310 and RX video QoS engine 312. The video compression decoder 314, and output audio/video interface 316 are eliminated since the required media output is a compressed video format. The wireless transmitter block 206′ would generally be used in the embedded context of FIG. 2B.

Clock Synchronization System Architecture

FIGS. 4 and 5 describe the video compression TS synchronization from a system level perspective. It should be understood that the figures are on a conceptual level only, and do not imply a specific Hardware (HW) or software (SW) implementation.

FIG. 4 is a functional block diagram of the Video QoS Engine 306 configured for the transmit mode and its placement in the transmit configuration of FIG. 3A. The Video Processing Block 400 is made up of the audio/video interface 302 and video compression encoder 304 (shown in FIG. 3A). The TX Video QoS Engine 306 further comprises a TX TS Engine 402, TS Clock Source 404, TS Clock Counter 406, and the Timestamp Clock Packet Generator 408. The TX TS Engine 402 packs the received TS data from the video compression encoder 304 into TS packets and timestamps these packets with a value derived from the TS Clock Source 404. The timestamped TS packets outputted by the TX TS Engine 402 are referred to as Timestamped TS Packets 412. The TS Clock Source 404 may be a crystal oscillator or voltage controlled oscillator (VCXO). The TS Clock Counter 406, which is also driven by the TS Clock Source 404, is used in conjunction with the Timestamp Clock Packet Generator 408 to generate a second set of time stamps that are unique to the present invention to be referred to as TS Clock Timestamp Packets 410. The TS Clock Timestamp Packets 410 are sent to the Wireless Transmitter 308 that transmits the TS Clock Timestamp Packets 410 to the Wireless Receiver 310 (see FIG. 5). The Wireless Receiver 310 sends the received TS Clock Timestamp Packets 410 to the receiver software (RX SW) of the RX Video QoS Engine 312 to obtain the synchronization of the RX VCXO 504 (please see FIG. 5) to the TX TS Clock Source 404. The RX SW passes the TS Clock Timestamp Packets 410 to the Clock Difference Calculation Block 512, which subtracts the Timestamp value received wirelessly from the wireless transmitter block 204 from the value sampled from Receiver TS Clock Counter 510 to compute a TS RX-TX clock difference value, The calculated TS RX-TX clock difference value is passed as a message to the Clock Control Algorithm 502 that performs clock synchronization work.

FIG. 5 is a functional block diagram of the video QoS engine 312 configured for the receive mode and its placement in the receiver configuration of FIG. 3B, The Video Processing Block 500 is made up of the audio/video interface 316 and video compression decoder 314 (shown in FIG. 3B). The RX Video QoS Engine 312 further comprises a Clock Control Algorithm 502 (to be explained in greater detail), VCXO 504, Rx TS Engine 506, RX Jitter Buffer 508, TS Clock Counter 510, and the Clock Difference Calculation 512. The Wireless Receiver 310 sends the received Timestamped TS Packets 412 to the RX Jitter Buffer 508. The VCXO 504 forms the heart of a phase-locked loop (PLL) that synchronizes the wireless receiver block 206 to the wireless transmitter block 204. The PLL is implemented in SW firmware (Clock Control Algorithm 502) that determines the voltage levels that control the VCXO.

Clock Control Algorithm Description

The clock synchronization algorithm of the present invention is a single-stage algorithm with fast response in case of sudden source clock frequency changes and smooth operation during periods of frequency stability. The phase corrections are performed with controlled limited frequency shift values, according to the requirements. The algorithm allows for no loss of phase synchronization, even when correcting large frequency shifts. The algorithm also provides for non-linear gain correction that filters efficiently the variance in the phase readings caused by residual jitter.

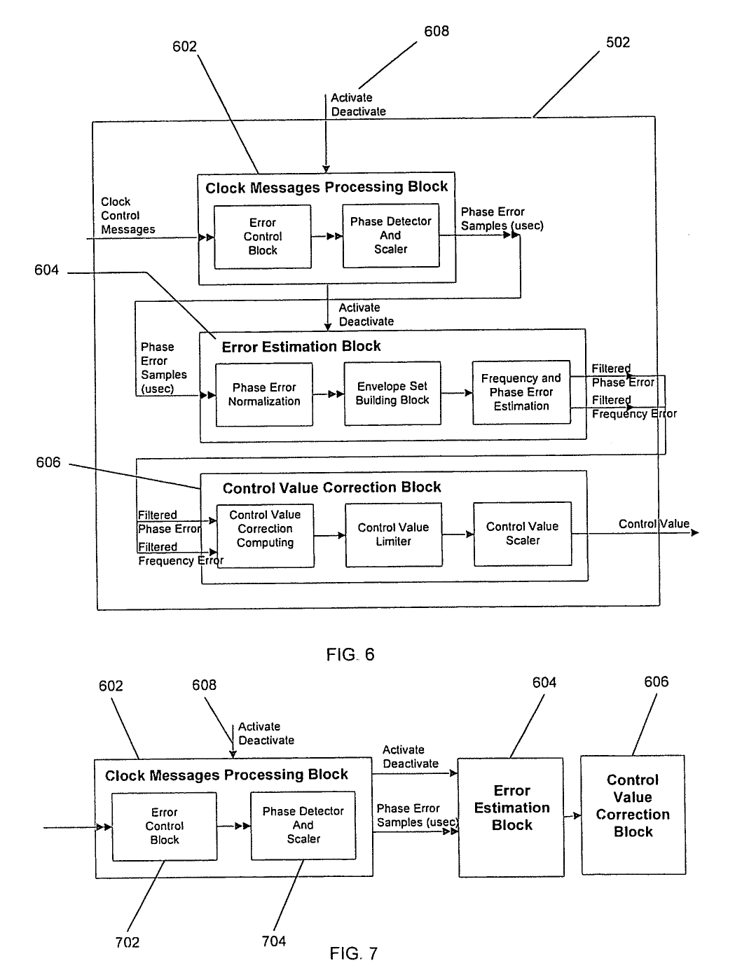

FIG. 6 is a functional block diagram of the Clock Control Algorithm 502 of the RX Video QoS engine 312 configured for the receive mode of FIG. 5. The Clock Control Algorithm 502 is comprised of the Clock Messages Processing Block 602, Error Estimation Block 604, and the Control Value Correction Block 606. The Clock Control Algorithm 502 receives Clock Control Messages based on the Clock Difference Calculation 512, and produces a control voltage to adjust the VCXO. In a preferred embodiment of the present invention, pulse width modulation (PWM) is the voltage means (Control Value) to control the VCXO. Therefore the control voltage would be referred to as a PWM Control value from the Control Value Correction Block 606.

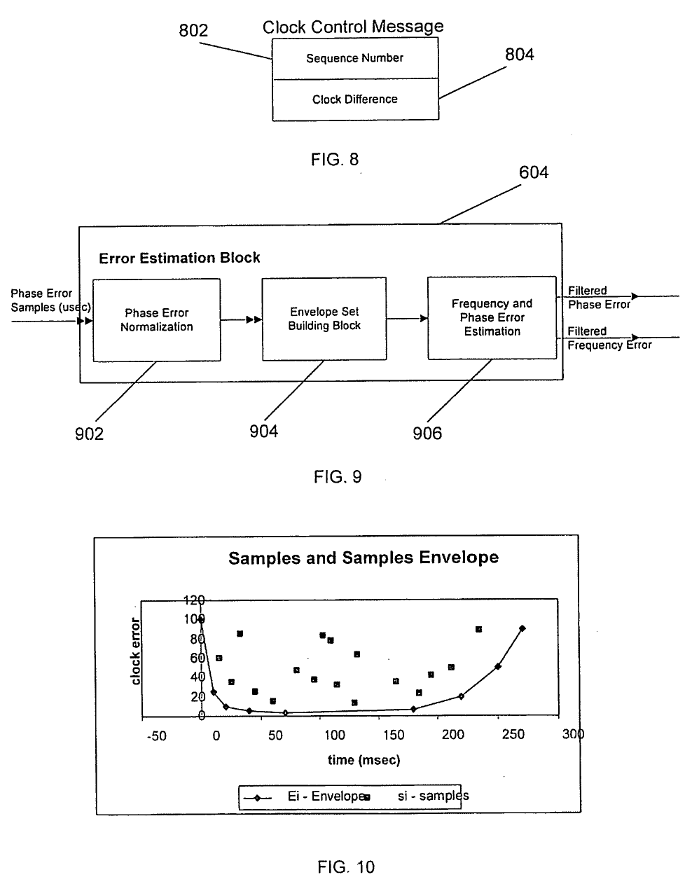

FIG. 7 is a functional block diagram of the Clock Messages Block 602 of FIG. 6, and its interrelation to the Error Estimation Block 604 and Control Value Correction Block 606, in accordance with some embodiments of the present invention. The Clock Messages Processing Block 602 receives clock control messages and implements the following functionality: error control 702 for received messages by establishing a reference value, and computing a phase error 704 output value relative to this reference, and scaling the phase output value 704 into microseconds that is then passed to the Error Estimation block 604. The timestamp information received from the wireless transmitter block 204 is processed and transformed by the RX SW Entity (RX Video QoS engine 312) processing these messages into an RX Internal Clock Control Message. The Rx Clock Control Message is then sent to the Clock Messages Processing Block 602. The Clock Control Message (please see FIG. 8) contains a Sequence Number Field 802 and a Clock Difference Field 804. The Sequence Number Field 802 is wrap-around (resets to zero after full count cycle) message counter originated at TX and incremented with each TX clock timestamp message. In a preferred embodiment of the present invention the Sequence Number Field 802 is a 32 bit wrap around counter. The Sequence Number Field 802 is used by the Error Control Block 702 to check and ensure message continuity. The Clock Difference Field 804 is also a wrap-around variable equal to the TS RX-TX clock difference that is computed at the wireless receiver block 206 lowest possible processing level, where messages received from TX are handled in order to prevent any additional jitter at the wireless receiver block 206. The units and size of the clock difference field may differ as a function of implementation.

The Activate/Deactivate interface 608 is used by the upper level applications to control the operation of the clock synchronization subsystem The general lines of operation are the following:

When the RX Unit Receive Jitter Buffer is empty (Sleep mode, Session not established, Communication failure) the clock subsystem should be deactivated. When the media buffering is completed before starting to push the compressed video (MPEG) packets via the TS interface the clock subsystem shall be activated.

In extreme abnormal situations the RX Jitter Buffer may increase too much and the system delay control mechanism may perform one or more packet SKIPs. This may affect the phase error in the clock control mechanisms, and the clock subsystem shall be deactivated and re-activated again.

The operation control entity also performs identical operations on the downstream Error Estimation Block to properly initialize its functionality.

NOTE: When the clock control subsystem is not active, the initialization and refreshing of the VCXO Control Value is within the responsibility of the upper level applications. Once the Clock Control Subsystem has been activated, no other application should modify the Control Value since this will result in system inconsistent operation.

The Error Control Block 702 uses the Clock Control Message Sequence Number field 802 in order to ensure the message sequence continuity. It performs the following operations:

After an ACTIVATION operation performed by the upper SW entities (following link startup or link recovery), the Error Control Block 702 enters a continuity verification phase, where it checks that a significant series of consecutive messages are received without sequence violations. In a preferred embodiment of the present invention at least sixty consecutive messages are checked to determine if there are sequence violations. During this phase, the clock control messages are dropped and not passed down the processing chain.

Once this initial stage is passed, the Error Control Block 702 starts to pass received messages to the Phase Detector block 704, while continuing to verify the message sequence continuity.

If a message is duplicated (the previous sequence number is repeated) the redundant message is dropped.

For any other sequence number violation condition, the message passing to the following processing levels is discontinued until it is assured that messages are again arriving in proper sequence—one way to do this is to check that at least 2 additional messages are received in correct sequence.

Clock control messages contain clock difference values stored as wrap-around unsigned values. For the ease of further handling, they have to go through some pre-processing.

The Phase Detection 704 function transforms the received unsigned valued into a signed phase error value. Since the clock difference values are always in a range less than half of the full available scale, the first received clock difference value is used as reference offset and all values transmitted down the chain are calculated as signed values relative to this offset:

referenceOffset=clockDifference(0)

and

clockError(n)=clockDifference(n)−referenceOffset

Scaling 706 is carried out in order to have the clock error value in desired units of time. In a preferred embodiment of the present invention the clock error value is scaled to microseconds.

FIG. 9 is a functional block diagram of the Error Estimation Block 604 of FIG. 6 that is comprised of Phase Error Normalization stage 902, an Envelope Set Building Bock 904, and a Frequency and Phase Error Estimation 906 stage.

Because of the inherent packet jitter in the WLAN networks, the per-sample timestamp information cannot provide accurate estimations of the phase and frequency difference between the TX and RX clocks. This functionality is provided by the Error Estimation Block 604 that uses a large batch of samples to obtain an accurate estimate.

The Clock synchronization mechanism is supposed to keep the clock phase error close to zero. In order to do so we need to declare the initial phase error as an offset reference value and calculate clock error values relative to this offset. This is referred to as Phase Error Normalization 902.

However, the first phase error value received from the pre-processing block may be affected by jitter and can be actually quite far away from the current minimum phase error values. In order to deal with this issue the following algorithm has been implemented. The first estimation cycle is used in order to calculate the phaseReferenceOffset, and is not used for correcting the VCXO control. The details of the algorithm are as follows:
1. The initial value of the phase reference offset is set to 0.
2. During the first batch of samples, the received phase error values are passed down unmodified to the rest of the Error Estimation Block 604—that by the end of the batch of samples will produce frequency error and phase error estimations.
3. The first value of the phase error is used as reference offset, and from now on all phase error values are calculated relative to this value.

phaseReferenceOffset=Filtered Phase Error(of first batch of samples)phaseError(k)=phaseError(k)−phaseReferenceOffset
4. In the first correction value correction step, the filtered phase error is set to 0.

The Envelope Set Building Algorithm 904 is at the core of the error detection mechanism. This block receives phase error samples and keeps only those samples that satisfy certain properties—defined below—and are called the Sample Envelope (please see FIG. 10). The resulting envelope curves are then used to make accurate estimations of the phase and frequency errors.

Simulations showed that building multiple Sample Envelopes and performing weighted averages of the frequency estimates resulted in more precise results compared to building only a Sample Envelope of order zero. Additionally, building multiple Sample Envelopes enabled the calculation of frequency error statistics, which yielded a reliability measure for the frequency error, and gave a criterion for determining which frequency estimates are invalid and should be ignored.

Sample Envelope Definition

For each clock error sample received we shall define a sample point sᵢ as the pair (sᵢ₋x, s_{i·}y), where x is the time at which the sample has been received, and y is the sample value (the phase error value). We shall use the notation Sᵢ=(Sᵢ₋x, S_{i·}y) for the sample points on the Sample Envelope defined below.

A Sample Envelope is an ordered subset of sample points E={S₀ . . . Sₙ} that have the following properties.

SE1. Sᵢ₋x<S_{i+1·}x for any i=0 . . . n−2, where n is the number Envelope points [i.e. an ordered set]

SE2. Having the slope of an Envelope segment Sᵢ, Sᵢ₊₁ defined as

slope(Sᵢ, Sᵢ₊₁)=(S_{i+1·}y−S_{i·}y)/(S_{i+1·}x−Sᵢ₋x),

the following relation shall hold:

slope(Sᵢ₊₁, Sᵢ₊₂)>slope(Sᵢ, Sᵢ₊₁₎ for any i=0 . . . n−3.

[i.e. the sample envelope is a concave shape pointing upwards]

SE3. For any sample point s not part of the Sample Envelope subset, there is an envelope point Eᵢ such as:

S_{i·}x<s.x<S_{i+1·}x, and

slope (Sᵢ, s)≧slope (Sᵢ, Sᵢ₊₁)

[i.e. all other points are contained within the Sample Envelope concavity—The curve is defined so that all samples are on or above the curve.]

FIG. 10 is a synthetic illustration of a samples batch with the Sample Envelope outlined. It should be noted that the graphical representation are for illustrative purposes only and do not reflect real process data.

Envelope Set

The very first envelope built using all the samples is called the envelope of order zero E(0). If all E(0) points are put aside, a new envelope may be built, E(1), and so on until all points are exhausted.

An Envelope Set of order N is the set of envelopes {E(0), E(1), . . . E(N−1)}. For practical frequency and phase error estimation purposes, only the first envelope orders are useful since they reflect the statistics of large number of samples.

The current algorithm of the preferred embodiment of the present invention uses an order 4 envelope set made of {E(0), E(1), E(2), E(3)}. However, it should be noted that N (the number of envelopes) can vary from one to any user defined number.

Building the Envelope Set

The building of the Envelope Set is a process that starts from adding the new samples to the outmost envelope, E(0). At the level of E(0), the algorithm may decide that certain points are no longer on E(0) and pass them to E(1) for processing. E(1) may keep them and perhaps pass its own previous points to E(2), and so on.

Since the algorithm is iterative, let's suppose that currently we have already built an Envelope E(k)={S₀ . . . Sₙ} and a new sample s is processed:

Step 1. Find the sample horizontal location.

The sample may be outside the envelope limits, or be within the time period covered by an envelope segment (let's call this segment Sᵢ, Sᵢ₊₁).

Step 2. Add the sample to the current segment, if applicable.

If the sample is outside the E(k) time span, it is always added to E(k), otherwise it is added only if the associated phase error value is located under the corresponding envelope segment. If the sample is not added to E(k), pass it to E(k−1) for processing and terminate.

Step 3. Eliminate additional points from envelope.

The inserted Sample Sj is taken as the reference and the 2 envelope segments to the left are checked for the envelope rule SE2. If SE2 does not hold, point Sj−1 is eliminated from E(k) and passed to E(k+1) for processing. The step is repeated until SE holds.

The same procedure is applied to the right side of Sj by eliminating Sj+1 points if necessary and passing them to E(k+1) processing.

Termination Condition

To support the cases when the clock jitter distribution is more scattered because of wireless noise, each sample batch used to build the Envelope Set takes 12 sec. The sample frequency used in the algorithm of the preferred embodiment of the present invention is 60 Hz (resulting in batches of 720 samples). Other embodiments or implementations of the present algorithm may use different sampling frequency rate as well as different sample intervals to build the Envelope Set. In addition the samples are not required to be uniformly spaced. A varying or random sampling rate may be used.

Both the frequency error and phase error estimations algorithms use the fact that for large sample batches the slope of the long envelope segments approximate fairly well the difference in the clocks speed—namely the frequency error. Such a large envelope segment is pictured in FIG. 11.

Frequency Error Estimation

The Frequency error freqErr(n) based on Envelope of order n is defined as follows:

Find the envelope segment which has the largest time span, for example find the value i that maximizes Si.x−Si−1.x.

Calculate the slope of segment i:

freqErr(n)=(Si.y−Si−1.y)/(Si.x−Si−1.x)

Scale this value to ppm units

In order to increase the accuracy of the estimation, the frequency error estimations obtained from the envelopes E(0) . . . E(n−1) are used in a weighted formula:

freqErr=W0*freqErr(0)+W1*freqErr(1)+W2*freqErr(2)+ . . . +Wn−1*freqErr(n−1)

The weighting of the envelopes is based on observed results and can be varied according to a particular system performance. A simplified version of the algorithm may consist of just a single envelop with no weighting applied. In an example of a preferred embodiment of the present invention employing an order of four envelope, estimations obtained from the first four envelopes E(0) . . . E(3) are used in the following weighted formula:

freqErr=0.30*freqErr(0)+0.37*freqErr(1)+0.22*freqErr(2)+0.11*freqErr(3)

where freqErr(k) corresponds to the frequency error estimation based on the E(k) longest segment in time. The frequency error is calculated in 27 MHz ppm units.

Frequency Error Statistics

It may happen that the frequency error estimation obtained from different envelops do not match; in such situations the estimation of the current batch is dropped and not used for corrections.

The level of fitness of the individual estimations is computed using the weighted average deviation from the freqErr calculated above:

avrgDeviation=W0*ABS(freqErr−freqErr(0))+W1*ABS(freqErr−freqErr(1))+W2*ABS(freqErr−freqErr(2))+ . . . +Wn−1*ABS(freqErr−freqErr(n−1))

where ABS( )=absolute value( ).

If the weighted average deviation is larger than a deviation threshold value, the frequency error evaluation is considered not valid and ignored. In an example of a preferred embodiment of the present invention, a deviation threshold value of 5 ppm is used.

The weighting of the average deviation is based on observed results and can be varied according to a particular system performance. In an example of a preferred embodiment of the present invention employing an order of four envelope, frequency error estimations obtained from the first four envelopes E(0) . . . E(3) are used in the following weighted formula:

avrgDeviation=0.30*ABS(freqErr−freqErr(0))+0.37*ABS(freqErr−freqErr(1))+0.22*ABS(freqErr−freqErr(2))+0.11*ABS(freqErr−freqErr(3))

where ABS( )=absolute value( ).

Other weighting values and even alternative weighting functions including mean square error or maximum absolute error may be used.

Phase Error Estimation

The phase error (clock difference) is estimated using a similar procedure.

First, the phase error corresponding to individual envelopes is computed taking as reference the longest envelope segment and extrapolating from it the phase error corresponding to the last envelope sample. If the envelope E(k) segment used for frequency estimation is Sᵢ, Sᵢ₊₁, and the last sample s, then

phaseError(k)=S_{i+1·}y+slope(Sᵢ, Sᵢ₊₁)*(s.x−Sᵢ₊₁x)

The phase error is then calculated using:

phaseErr=W0*phaseErr(0)+W1*phaseErr(1)+W2*phaseErr(2)+ . . . +Wn−1*phaseErr(n−1)

The weighting of the phase error is based on observed results and can be varied according to a particular system performance. In an example of a preferred embodiment of the present invention employing an order of four envelope, phase error estimations obtained from the first four envelopes E(0) . . . E(3) are used in the following weighted formula:

phaseErr=0.30*phaseErr(0)+0.37*phaseErr(1)+0.22*phaseErr(2)+0.11*phaseErr(3)

Representation Units

The units of the output values of the Error Estimation Block 604 are as follows.

The phase error is represented in microseconds units.

The frequency error units are hundreds of 27 MHz ppb units (i.e. 0.1 ppm units).

Other units may be chosen depending on system implementation requirements.

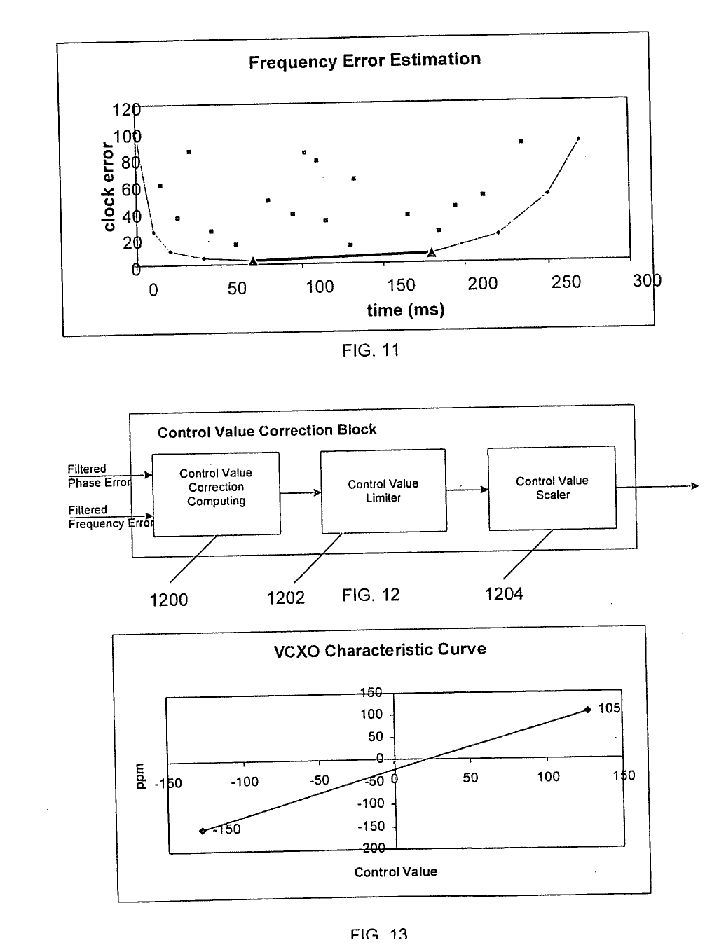

FIG. 12 is a functional block diagram of the Control Value Correction Block 606 of FIG. 6 that is comprised of Control Value Correction Computing 1200, Control Value Limiter 1202, and Control Value Scaler 1204 stages.

The Control Value Correction Computing Block 1200 carries out the following computation:

The Loop Control Algorithm computes a new Control Value (CVAL) correction value based on the phase and frequency errors, as follows:

CVALₙ=CVALₙ₋₁+δ_{CVAL}(freqErrₙ, phaseErrₙ),

where CVALₙ is the next Control Value and CVALₙ₋₁ is the previous Control Value.

To preserve accuracy in the preferred embodiment, the Control Values are calculated using units of an order of magnitude (×10) larger than the actual value. The correction function δ_{CVAL} is using the VCXO device characteristic curve (please see FIG. 13) to convert into Control Value units a computed frequency error expressed in ppm units:

δ_{CVAL}=−ppmToCVAL(ppm₁(freqErrₙ)+ppm₂(phaseErrₙ))

The ppmToCVAL is device dependent and has to be fit to the particular VCXO component. For the example of FIG. 13, the simplest approach is to define ppmToCVAL(x) as multiplying x by the reciprocal of the average slope of the graph, or alternatively as multiplying x by the reciprocal of the average slope of the region around the center of the graph.

In ideal conditions (no jitter), the function ppm1 would replicate identically the frequency error (i.e. ppm₁(x)=x). In this case the Control Value correction formula would be:

δ_{CVAL}=−ppmToCVAL(freqErrₙ+ppm₂(phaseErrₙ))

However, because of the remaining jitter influencing the freqErr values, the ppm1 function is non-linear to attenuate jitter.

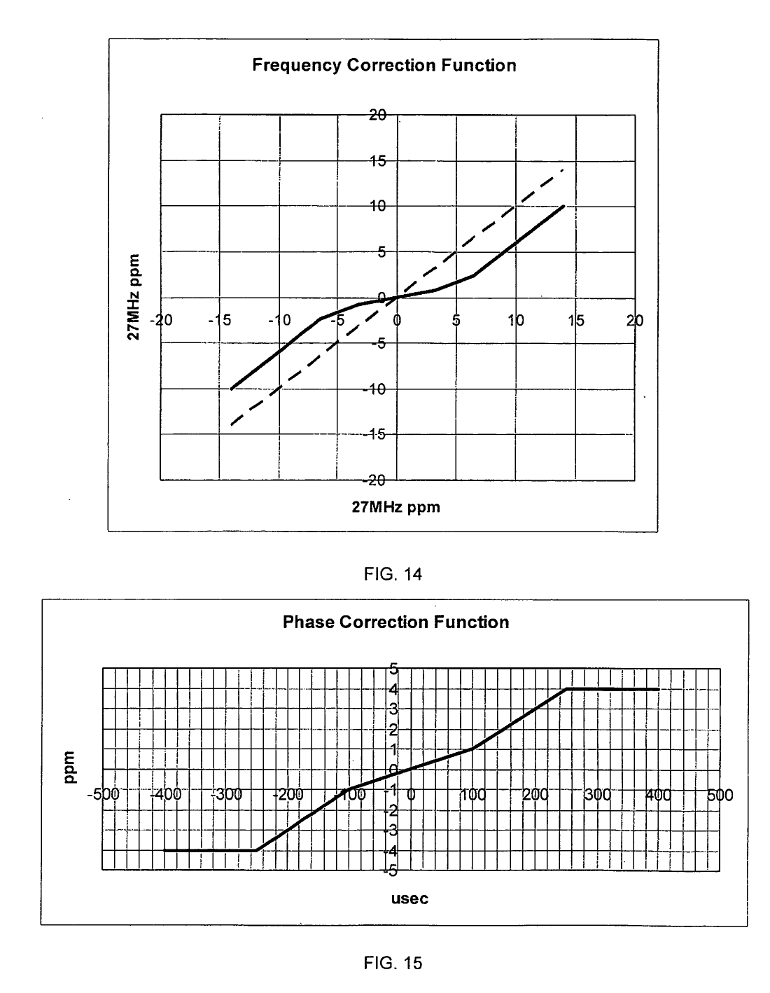

FIG. 14 illustrates an example graph of a Frequency Correction Function. The Frequency correction function is non-linear and acts in a gradual manner to avoid oscillation.

### Mathematically:

for x<=−6.4 ppm₁(x)=x+4

for −6.4<x<−3.2 ppm₁(x)=x/2+0.8

for −3.2<=x<=3.2 ppm₁(x)=x/4

for 3.2<x<6.4 ppm₁(x)=x/2−0.8

for x>=6.4 ppm₁(x)=x−4

The formulas have as input the frequency error in 27 MHz ppm units, and have as output a ppm correction value. As in the case of the phase correction, the Control Value units are obtained using the specific VCXO characteristic curve slope.

FIG. 15 illustrates an example graph of a Phase Correction Function. The Phase correction function is non-linear.

### Mathematically:

for x<=−250 ppm₂(x)=−4

for −250<x<−60 ppm₂(x)=(x+50)/50

for −60<=x<=60 ppm₂ (x)=x/100

for 60<x<250 ppm₂(x)=(x−50)/50

for x>=250 ppm₂(x)=4

The phase error units are microseconds and the output units are computed in 27 MHz clock ppm units.

Since calculations may sometimes exceed the actual scale, the Control Value has to be corrected to minimum and maximum values. The limits are set by the Control Value Limiter 1202 of FIG. 12:

If (CVALₙ<MIN_{—}CVAL)CVALₙ=MIN_{—}CVAL

If (CVALₙ>MAX_{—}CVAL)CVALₙ=MAX_CVAL

The MIN_CVAL and MAX_CVAL values have to take into account the current scaling (see below).

As mentioned before, the CVAL values are calculated using an order of magnitude larger than the actual values. To perform actual commands, the CVAL values are scaled down with a factor of 10: This is carried out by the CVAL Scaler Block 1204 of FIG. 12.

CVALControlValueₙ=CVALₙ/10

Please note that the original CVALₙ values are left intact by scaling for use in the next control calculation step.

CVALControlValue is used as a control voltage of the VCXO.

If Pulse Width Modulation is employed in the correction process then a pwmControlValue is used to drive a Pulse Width Modulation modulator that is connected to the control voltage of the VCXO.

Alternatively, if the CVALControlValue feeds a D/A (digital to analog converter) that is connected to the control voltage input of the VCXO; the changing of the control voltage of the VCXO will change the output frequency of the VCXO.

In yet another alternative implementation, the wireless receiver block 206, instead of using a VCXO, may have a fixed frequency clock source that is divided down to the required frequency. The division ratio is varied over a small range, and thus the required frequency can also vary over a small range. In this case, the CVALControlValue will be scaled appropriately and will be used to determine the division ratio, and in this manner will control the output frequency.

Video Streaming Description

The Rx TS Engine 506 derives timestamp values from the clock output generated by the VCXO 504, or from the fixed frequency clock source of the alternative embodiment. The application specific delay of a particular multimedia signal implementation will dictate to the Rx TS Engine 506 what the required difference between the derived timestamp value and the timestamps that are part of the received Timestamped TS Packets 412. Subsequently, the Rx TS Engine 506 processes the received Timestamped TS Packet 412 that is first in the Rx Jitter Buffer 508. As explained earlier, the received Timestamped TS Packet 412 is composed of a Timestamp and of a TS packet. The RX TS Engine 506 examines the Timestamp of the received Timestamped TS Packet 412. At the instant the difference between the Timestamp of the received Timestamped TS Packet 412 and the Rx TS Engine 506 derived timestamp equals the required difference, the RX TS Engine 506 sends the TS packet of the received Timestamped TS Packet 412 to the video compression decoder 314, and clears the first entry in the Rx Jitter Buffer 508.

In an alternative embodiment, according to the delay required by the multimedia signal application, the Rx TS Engine 506 will determine a range of required difference values between the Rx TS Engine 506 derived timestamp and the timestamps that are part of the received Timestamped TS Packets 412. Subsequently, the Rx TS Engine 506 processes the received Timestamped TS Packet 412 that is first in the Rx Jitter Buffer 508. The RX TS Engine 506 examines the Timestamp of the received Timestamped TS Packet 412. At the instant the difference between the Timestamp of the received Timestamped TS Packet 412 and of the Rx TS Engine 506 derived timestamp falls into the range of required difference, the RX TS Engine 506 sends the TS packet of the received Timestamped TS Packet 412 to the video compression decoder 314, and clears the first entry in the Rx Jitter Buffer 508.

In both of the aforementioned video streaming embodiments, the Rx TS Engine 506 keeps repeating the process with respect to the received Timestamped TS Packet 412 that is first in the Rx Jitter Buffer 508. In this manner the Rx TS Engine 506 manages to supply the TS packets to the video compression decoder 314 with minimal jitter.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed is:

1. A system for wireless streaming of a multimedia signal between a media source and a display device, wherein said system comprises a transmitting means in functional contact with said media source, and a receiving means in functional contact with said display device, and wherein clock synchronization is maintained between said transmitting means and said receiving means through the use of a Clock Control algorithm and a series of first time stamped signals and a series of second time stamped signals generated by said transmitting means for the proper encoding and decoding of said multimedia signal; and
wherein said series of first time stamped signals and said second series of time stamped signals are in addition to the timing signals that are part of said multimedia signal; and
wherein said multimedia signal is transmitted in packets of information between said transmitting means and said receiving means.

2. The system of claim 1 wherein said multimedia signal is compressed in the MPEG-2 Transport Stream standard.

3. The system of claim 1 wherein said media source provides an analog signal to said transmitting means.

4. The system of claim 1 wherein said media source provides a digital signal to said transmitting means.

5. The system of claim 1 wherein said transmitting means further comprises:
a transmit (TX) Video QoS Engine; and
a wireless transmitter block; and
wherein said TX Video QoS Engine derives and provides said series of first time stamped signals and said second series of time stamped signals to said wireless transmitter block.

6. The system of claim 5 wherein said TX Video QoS Engine further comprises the following functional blocks:
a TX TS Engine;
a TS Clock Source;
a TS Clock Counter; and
a Timestamp Clock Packet Generator;
wherein said TS Clock source is functionally connected to said TS Clock Counter; and
said TS Clock Counter is functionally connected to said TX TS Engine and said Timestamp Clock Packet Generator; and
wherein said TX TS Engine timestamps said packets with values derived from said TS Clock Source and said TS Clock Counter to form said series of first time stamped signals; and
wherein said Timestamp Clock Packet Generator produces said second series of time stamped signals based on values derived from said TS Clock Source and said TS Clock Counter.

7. The system of claim 1 wherein said receiving means further comprises:
a wireless receiver block;
a Receive (RX) Video QoS Engine
wherein said wireless receiver block receives said series of first time stamped signals and said series of second time stamped signals and sends said series of first time stamped signals and said series of second time stamped signals to said RX Video QoS Engine; and
wherein said RX Video QoS Engine further comprises the following functional blocks:
a RX VCXO;
a RX Jitter Buffer;
a RX TS Engine;
a TS Clock Counter;
a Clock Difference Calculation block; and
said Clock Control Algorithm; and
wherein said TS Clock Counter generates a series of receiver time stamp signals; and
wherein said series of first timestamp signals is further comprised of said packets and a series of time stamp signals generated by said transmitting means; and
wherein said RX Video QoS Engine obtains synchronization of said RX VCXO to said transmitting means by taking said series of second time stamped signals that has been sent by said transmitting means and said series of receiver time stamp signals to compute a TS TX-RX clock difference; and
wherein said clock difference value is passed as a message to said Clock Control Algorithm that performs said synchronization.

8. The system of claim 7 wherein said Clock Control Algorithm further comprises the following functional blocks and signals:
a Clock Messages Processing Block;
an Error Estimation Block; and
a Voltage Correction Block; and
a Clock Control Message signal;
a Phase Error Sample Signal;
an Envelope Set Building Block Algorithm; and
a control voltage; and
wherein said Clock Control Message further comprises a Clock Difference value obtained from said Clock Difference Calculation block; and
wherein said Clock Messages Processing Block is inputted said Clock Control Message signal from said Clock Difference Calculation Block, and said Clock Messages Processing Block derives a Phase Error Sample signal based on said Clock Difference value; and
wherein said Phase Error Sample signals are inputted into said Error Estimation Block to calculate an accurate estimate of phase and frequency difference between said transmitting means and said receiving means; and
wherein said Error Estimation Block uses an Envelope Set Building Block algorithm to determine said estimate of phase and frequency differences; and
wherein said estimates of phase and frequency differences are inputted into the Voltage Correction Block that provides a control voltage to adjust said VCXO; and
wherein said VCXO is functionally connected to said RX TS Engine that draws said packets from said RX Jitter Buffer and forwards said packets to said functionally connected display device; and
wherein the timing of the drawing of said packets from said RX Jitter Buffer is determined by said VCXO together with the timestamps which are part of said series of first time stamped signals.

9. The system of claim 8 wherein in said Clock Control Message signal has a sequence number that is derived from the timestamp information received from said transmitting means; and
wherein said Clock Messages Processing Block checks for message sequence continuity, and when a message sequence discontinuity is detected, certain messages are ignored.

10. The system of claim 9 wherein in said Clock Messages Processing Block checks that a predefined number of consecutive Clock Control Messages are received without sequence violations, and that during this sequence checking phase said Clock Control Messages are dropped.

11. The system of claim 9 wherein if a Clock Control Message sequence number is duplicated, the redundant message is dropped.

12. The system of claim 9 wherein if there is Clock Control Message sequence violation condition, message passing to the following processing levels is discontinued, until it is determined that received messages have arrived in correct sequence.

13. The system of claim 8 wherein said Envelope Set Building Block Algorithm comprises the building of a sample envelope curve, wherein all sample phase error points lie essentially on or above said sample envelope curve.

14. The system of claim 8 wherein said Envelope Set Building Block Algorithm comprises the building of a sample envelope curve with a concave (bath tub) shape,

15. The system of claim 8 wherein said Envelope Set Building Block Algorithm comprises the building of a sample envelope curve with a monotonically increasing slope,

16. The system of claim 8 wherein said Envelope Set Building Block Algorithm has sample points that are a function of the time the sample was received (x-coordinate), and sample value (phase error) (y-coordinate).

17. The system of claim 8 wherein said sample envelope curve is built by an iterative process.

18. The system of claim 8 wherein the slope of the longest sample envelope segment that joins consecutive sample points approximates the difference in said transmitting means and receiver means clock speed (frequency error).

19. The system of claim 8 wherein the slope of the longest sample envelope segment that joins consecutive sample points can be used to estimate the clock difference (phase error).

20. A method for clock recovery and synchronization of a wireless streamed multimedia signal between a media source and a display device in a system, wherein said system comprises a transmitting means in functional contact with said media source, and a receiving means in functional contact with said display device, and wherein clock synchronization is maintained between said transmitting means and said receiving means through the use of an algorithm and a series of first time stamped signals and a series of second time stamped signals generated by said transmitting means for the proper encoding and decoding of said multimedia signal; and
wherein said series of first time stamped signals and said second series of time stamped signals are separate from the synchronization signals that are part of said multimedia signal; and
wherein said algorithm determines clock frequency and clock phase error; and
wherein said algorithm is based on Envelope Set Building.

21. The method of claim 20 wherein said multimedia signal is compressed in the MPEG-2 Transport Stream standard.

22. The method of claim 20 wherein said Envelope Set Building Block Algorithm comprises the building of a sample envelope curve, wherein all sample phase error points lie essentially on or above said sample envelope curve.

23. The method of claim 20 wherein said Envelope Set Building Block Algorithm comprises the building of a sample envelope curve with a concave (bath tub) shape,

24. The method of claim 20 wherein said Envelope Set Building Block Algorithm has sample points that are a function of the time the sample was received (x-coordinate), and sample value (phase error) (y-coordinate).

25. The method of claim 20 wherein said sample envelope curve is built by an iterative process.

26. The method of claim 20 wherein said sample envelope curve has a monotonically increasing slope.

27. The method of claim 20 wherein the slope of the longest sample envelope segment that joins consecutive sample envelope points approximates the difference in said transmitter and receiver clocks speed (frequency error).

28. The method of claim 20 wherein the slope of the longest sample envelope segment that joins consecutive sample envelope points can be used to estimate the clock difference (phase error).

29. The method of claim 20 wherein said Envelope Set Building Block Algorithm uses a plurality of envelope sets.

30. A method to minimize jitter in a system that wirelessly streams a multimedia signal between a media source and a display device, wherein said system comprises a transmitting means in functional contact with said media source, and a receiving means in functional contact with said display device, and wherein said method comprises:
using special timestamp packets; and
means for providing higher priority to said special timestamp packets at said transmitting means than other packets of said multimedia signal.

31. The method of claim 30 further comprising fast interrupt processing at said receiving means of said special timestamp packets that reduces jitter in said system.

32. The method of claim 30 wherein said special timestamp packet is prepared in advance, however the actual value of said timestamp is inserted into said special timestamp packet only upon transmission by said transmitting means.

33. The method of claim 30 wherein when there are no packets of said multimedia signal to be transmitted by said transmitter, said special timestamp packet is prepared and sent by said transmitting means.

34. The method of claim 30 wherein whenever said special timestamp packet is prepared, said special timestamp packet is given priority so that it will be transmitted before any other packet that may already be waiting to be transmitted.

35. The method of claim 30 wherein said transmitting means further comprises a plurality of transmit queues; and
wherein said method further comprises providing a special transmit queue for said special timestamp packets; and
wherein said special transmit queue is assigned a higher priority than some of the other transmit queues in said plurality of transmit queues.

36. The method of claim 30 wherein there is no retransmission of said special timestamp packets that are not received by said receiver means.
